(19) United States
(12) Patent Application Publication
(10) Pub. No.: US 2004/0017981 A1
(43) Pub. Date: Jan. 29, 2004

(54) Capillary valve, connector, and router

(76) Inventors: Stevan Bogdan Jovanovich, Livermore, CA (US); David John Roach, Los Gatos, CA (US); Iuliu-Ioan I. Blaga, Sunnyvale, CA (US)

Correspondence Address: Amersham Biosciences Corp, 800 Centennial Avenue, Piscataway, NJ, 08855, US

(21) Appl. No.: 10/417,546

(22) Filed: Apr. 17, 2003

Related U.S. Application Data
(63) Continuation-in-part of application No. 09/770,412, filed on Jan. 25, 2001, now Pat. No. 6,551,839.
Application No. 09/770,412 is a division of application No. 08/927,645, filed on Sep. 11, 1997, now Pat. No. 6,190,616.
(60) Provisional application No. 60/402,959, filed on Aug. 13, 2002.

(51) Int. Cl. G02B 6/38

(52) U.S. Cl. 385/68; 385/60

(57) ABSTRACT

A capillary connector having one or more capillary tubes entering a first end and terminating with an open end at a level face on the opposite side of the connector. The face is held by a coupler and brought into a biased abutment such that the open capillary ends are in fluid communication with the ends of microchannels on an abutting surface. These microchannel ends may be capillary tube ends from a second capillary connector or may be openings of microchannels on a substrate. The connector may be a fiber-optic connector modified to hold capillary tubes. Alternatively, the connector may be a substrate having microchannels extending through the substrate and terminating at a level face on the substrate. The coupler may receive the capillary tube, which passes through the coupler. This coupler may be attached to a substrate surface to allow the capillary connector to be joined to the substrate. Alternatively, the coupler includes a tray that holds the connector and a receiving substrate such that the ends of microchannels are brought into alignment. In any of these embodiments, the ends of the capillary may be designed to extend slightly from the level connector face, such that upon connection the biasing force is concentrated at the capillary tube end.

### CROSS-REFERENCE TO RELATED APPLICATIONS

This application is a continuation-in-part of U.S. provisional application No. 60/402,959 filed Aug. 13, 2002. This application is also a continuation-in-part of U.S. patent application Ser. No. 09/770,412 filed Jan. 25, 2001, which is a divisional of U.S. patent application Ser. No. 08/927,645 filed Sep. 11, 1997, now U.S. Pat. No. 6,190,616 granted Feb. 20, 2001.

### FIELD OF THE INVENTION

This invention relates generally to capillary valves and devices for interconnecting capillary tubes with each other, with microfabricated devices, and with macroscale devices.

### BACKGROUND OF THE INVENTION

Capillary tubes are useful in a wide range of microfluidic applications, particularly where volumes on the order of a microliter or smaller are handled. Capillaries are made of glass, metal, silica, or a polymer. The outer diameter of a capillary tube ranges from under 100 to over 750 microns. The diameter of the inner bore ranges from 2 to over 500 microns. With only minimal amounts of chemicals required, systems utilizing capillary tubes are well suited for producing high sample throughput with minimal use of space and materials. In electrophoretic applications, the high surface to volume ratio of capillaries enables the use of high voltages with low Joule heating. The use with high voltages results in the ability to electrophoretically separate compounds in capillary tubes at several times the speed and resolution available with traditional slab electrophoretic separation.

Numerous applications have developed to take advantage of the benefits that capillary tubes provide. For example, one use of capillary tubes is in microfluidic devices where capillary tubes are used to transport small amounts of fluid from one location to another. Another application using capillary tubes entails temporarily sealing both ends of a capillary tube to form a nanoscale reaction vessel. Finally, chromatographic devices utilize capillary tubes to provide a separation column for substances. The substances can then be separated based on their physical properties, such as mass, size, or shape. Such applications include gas chromatography and liquid microbore chromatography.

All of these applications require that sections of capillaries be connected to each other. For example, gas chromatography will require an injection port that can introduce a sample into a flow stream. The varied uses of capillary tubes require capillary connectors that are both versatile and resilient. The physical stresses placed on these capillary connectors are most demanding. The connector must be inert to reactive substances that flow through the capillaries, including organic solvents. The connector must remain leak free when used to contain a liquid, gas, or a fluid separation matrix at pressures ranging from 0 to 10,000 PSI.

In high electric voltage applications, the connector must be insulated from these voltages, which can be over 10,000 volts. The connector should add negligible additional volume to the capillary column to avoid degrading separation resolution in electrophoretic applications. In addition, the connector should be able to act as an interface for connecting macroscale devices (such as injectors, fluid reservoirs, or sample depositors) to microscale capillary tubes. Finally, to aid in the simple manipulation of the connector, the connector must be reusable and simple to connect.

Microfabricated devices with microchannels microfabricated onto, commonly called microchips, are another way to achieve capillary dimension and smaller channels with many of the same applications as capillaries. Microchips are typically fabricated either by etching channels into a substrate using photolithography or other patterning methods or by molding or embossing plastic substrates, along with other fabrication methods. In addition to the small volumes used by capillaries, capillary channels in microchips also offer the advantages of adding additional channels by changing a CAD drawing, ability to integrate different functionalities on the same monolith, and more complex structures and connections than are currently available with capillaries. However, it is not currently possible to connect capillary channels between two microchips. In this application the terms capillary and capillary tube will be used to encompass capillary channels on microfabricated devices as well as capillaries tubes.

The varied uses of the connector in a number of applications require that the connector serve several different functions. Primarily the connector must be able to serve as a leak free, high-pressure connector for two or more capillary tubes. The connector should provide a number of other functions as well. The connector could serve as a valve, enabling both the ability to close an end of a section of capillary tubing and the ability to route fluid from one capillary tube into a selectable second capillary tube. In addition, it would be useful for the connector to function as a manifold enabling the combination of the flow streams from a plurality of input capillary tubes to channel into a single output capillary tube or splitting a flow stream from a single capillary tube into multiple flow streams in multiple capillary tubes. The connector preferably would have negligible dead space volume, both as a connector and as a valve. Finally, the connector should enable connection of macroscale devices to microscale capillary tubes.

By combining these features within one connector, a multitude of uses becomes a possible. By using two such connectors at the two ends of a section of capillary tubes, a reversibly sealable nanoscale reaction chamber is formed. If the first connector also functions as a manifold, a plurality of input lines could flow into this nanoscale reaction chamber before it is sealed to allow for mixing a number of chemicals in the reaction. If the output line also functions as a manifold, once the reaction is complete, the mixture could be divided into multiple lines for sending flow streams to multiple analytical devices or to a waste reservoir.

In the past, several couplers have been developed to attach together the ends of capillary tubes. Some capillary connectors employ a ferrule with a longitudinal bore therethrough for inserting the ends of the capillaries to be coupled together and a compression fitting for mechanically compressing the ferrule to seal the connector. U.S. Pat. No. 5,288,113 to P. H. Silvis et al. teaches a heat-resistant connector for releasably joining end portions of two capillary tubes in end-to-end fashion for use in chromatography. U.S. Pat. No. 5,540,464 issued to Picha, describes a capillary connector where the ends of a capillary tube are press fit into a resilient member with a tapering throughbore. A split sleeve holds a pair of these members together in mutually facing alignment, with the throughbore aligned to enable two capillary tubes to come into fluid communication. U.S. Pat. No. 5,453,170 to S. Krstanovic et al. teaches coupling a capillary to a fine wire electrode to form an ion detector.

Some of the capillary connectors demonstrate the ability to couple together more than two capillaries. U.S. Pat. No. 5,487,569, issued to Silvis et al., teaches a glass insert with a plurality of legs connected at a central portion. Each leg has a tapered inner bore that receives one end of a capillary tube. On each of these legs is annularly mounted a connecting member containing a sealing ferrule for making a seal between the capillary and the leg. U.S. Pat. No. 5,494,641, issued to Krstanovic, describes a system for connecting any number of capillary tubes into a system by mounting the capillary tube within a cavity in a mechanical fastener. The capillary tube can then be attached to any apparatus that has been adapted to accept the fastener.

These capillary connectors function to link sections of capillary tubes. It would be advantageous to have a connector that could serve other functions.

Currently, there are several devices that have been used as valves or gates for capillaries. One capillary valve requires that the capillary tubes be attached to holes in a thin wafer, such as a silicon wafer. A flexible membrane is positioned on the opposite side of the wafer. By exerting pressure on the membrane, the membrane is pressed against the holes in the silicon wafer and the valve is closed. U.S. Pat. No. 5,492,555, issued to Strunk et al., describes a two dimensional capillary gas interface. One part of the device is a bimodal six way capillary valve. This valve comprises a cylindrical section with a longitudinal axis perpendicular to the plane containing the longitudinal axis of three sections of capillary tubes. The valve operates by rotation of the cylindrical section to align the ends of the capillary tube in the tangential plane of the cylinder with the ends of other capillary tubes bringing the section into fluid communication. Further rotation will bring the ends of the capillary tubes in the rotating cylindrical section out of communication with the capillary tubes, closing the valve. This valve has significant dead volume of several microliters.

The inner diameters of capillary tubes must connect to devices that are an order of magnitude or more larger. This has been a persistent problem for the field of microfluidics. Some attempts have been made to provide for a macroscale to microscale interface. For example, capillary tubes have been attached to pressurized reservoirs. An inlet to the reservoir is capped by a rubber septum. A macroscale injector, such as a syringe, can introduce a sample into the reservoir, and the sample will be pressure driven into the capillary tube. After repeated injections through the septum, the septum will no longer remain pressure tight and will require replacement.

Both the connectors and the valves presently available are not ideal. None of these devices combine in one connector the ability to connect a number of capillaries, but also to act as a zero dead volume valve, or as a manifold, or as a router of fluid. As noted above, such a connector would greatly enhance the utility and ease of use of many systems that use capillary tubes or microchips. Furthermore, no device presently available is an adequate interface between macroscale and microscale devices or between two microscale devices. An object of the invention was to provide improved connectors and valves for capillary tubes, to connect tube capillaries to microscale devices, to connect microscale devices to microscale devices, and to connect capillary tubes and microscale devices with macroscale devices.

### SUMMARY OF THE INVENTION

The above object has been achieved with a capillary connector, which is able to join into fluid communication a plurality of capillary tubes and microchannels, but also can function as a valve, a fluid router, a manifold, a reaction chamber and a macroscale to microscale connector. Each connector is simple in design and is rapidly and easily connected and disconnected. The connector has negligible dead volume whether functioning as a capillary tube connector, a valve, a fluid rotor, a manifold, a reaction chamber or a macroscale-to-microscale connector.

The basic connector consists of two members, with each member consisting of the same basic parts. Each member includes input fibers, which are usually capillary tubes or microchannels on a microdevice, entering the member, with the input bundle terminating at a level face. A fastener connects these two members and holds the faces in mutually biased alignment. The fibers packed within the ferrule would be affixed within the bundle and ferrule and be relatively non-rotating in relation to the bundle and ferrule. By rotation of the ferrules, the rotational orientation of the fibers about an axis in the first bundle would be altered in relation to the orientation of fibers about the same axis in the second bundle, but the axially parallel alignment would remain. Each member of the connector could have an indicator to indicate its orientation.

Similarly, when the capillary tubes or microchannels in a microfabricated device are in a linear arrangement, each member will include input fibers arranged in a linear arrangement with the input bundle terminating at a level face. A fastener connects these two members and holds the faces in mutually biased alignment. The fibers packed within the ferrule would be affixed within the bundle and ferrule and be relatively non-rotating in relation to the bundle and ferrule. By lateral movement of the ferrules, the alignment of fibers in the first bundle would be altered in relation to the alignment of fibers in the second bundle. When the members were moved to align with portions of the other member with no capillary tubes or microchannels, a closed valve would be formed. When the members were moved to align with portions of the other member with different microchannels, a router would be formed.

With this basic connector, several different functions are possible. The connector can function to put two corresponding capillary tubes into fluid communication and thus function as a basic connector. Unlike other available connectors, this connector would also function as a connector between macroscale devices and microscale capillary tubes, between microchannel openings and capillary tubes, and between microchannel opens on two microdevices. It can also function to connect multiple capillaries in one member to a second member with either an equal number of capillaries or with only a single capillary.

In addition, the connector can function as a valve. When the ends of the capillaries in both ferrules are aligned, the valve is open. If the ferrule of the second member is rotated or moved in relation to the orientation of the first ferrule, the ends of the capillary tubes can be displaced in relation to each other so that non-corresponding solid cylinders, which may be glass, glass fibers, metal, plastic or a plugged capillary, are aligned with the capillaries and the ends of the capillary tubes will be blocked or closed or the alignment is with a solid surface. These cylinders are generally referred to as non-hollow fibers and plugged capillaries, since these are preferred elements, the main consideration being an outer diameter, which is the same as a corresponding capillary which it faces at a ferrule-to-ferrule interface. The terms non-hollow fibers and plugged capillaries will also be used to encompass a solid surface such as the non-etched or flat surface at the end of a microdevice or macrodevice such as an endcap. In other words, when non-hollow fibers are contained within the ferrule of a first connector member, the flow within a capillary could be blocked by orienting the ferrule of a second connector member such that the end of the capillary of the second connector member and the end of the non-hollow fiber of the first connector member are in alignment. The valve is also closed whenever the ends of the capillaries are not aligned with capillaries on the opposing member, including when the ends are aligned with the inter-capillary surfaces. This valve that is created has essentially no dead volume and is simple to manipulate by rotation or linear movement. The alignment marks, scale or notches on the ferrules would indicate if the valve is open or closed. A calibrated scale will allow partial blockage of a capillary by incomplete overlap with the open end of a capillary. If the non-hollow fibers are fiberoptic fibers, alignment could be indicated by passing light through the fibers and detecting if the light passes through a distal end of the fiber. This rotatable valve can also function as a router. For example, if capillaries aligned on ferrules of both members are rotated such that capillaries on a first member now align with different capillaries on the second member, a router is created. Similarly, depending on the application, some capillaries on the first member can be routed to capillaries on the second member, while other capillaries are closed.

Typically, rotation of the ferrule is effected by manual operation. It is also possible to operatively associate the ferrule with a motor to effect automated controlled rotation of the ferrule. The motor would operate in accordance with instructions from a controller that a user would program to give desired results. The orientation of the ferrules would then be automatically controlled with precision timing for volumetric accuracy, especially if variable blockage of a capillary is implemented.

The basic connector, comprised of the two connector members mutually biased against each other, readily transforms into a manifold. This would require that one of the ferrules be associated with a bundle of packed capillary tubes and the second ferrule be associated with a bundle containing one capillary tube. Between these two ferrules would be placed a fluid combining channel. The channel would bring into fluid communication the flow streams of the plurality of tubes in the first member with the inner bore of the single capillary in the second member. The same result could also be achieved by slightly recessing the capillary tube in one member and having a groove extend between the recessed capillary tubes. This would allow the inner bore of the capillary tube in the second member to come into fluid communication with the first set of capillary tubes. Alternatively, a plurality of capillary tubes in one bundle and ferrule can be associated with a single capillary tube in another bundle and ferrule whereby the inside diameter of the single capillary is large enough to encompass more than one capillary tube in the other ferrule.

This basic connector is adaptable for many different uses. By placing oppositely charged electrical leads on the opposite sides of connector members and filling the tubes with a conducting media, the media will conduct electricity without shorting on the connectors. This enables capillary electrophoresis reactions to be run in the tubes joined by these connectors.

In addition to the use of the present invention wherein two connector members are joined together, the invention also can be used as a single connector member that could be joined to any other device that contains a port member to receive the connector member. This connector member would be comprised of a rotatable ferrule containing at least one capillary tube terminating at a substantially level surface. An alignment indicator on the ferrule, such as a mark or notch, would indicate the orientation of the capillary tubes within the ferrule. The member would have an attachment device, such as an annular nut, capable of attaching to a mating mount, such as a threaded protrusion of a receiving well. This would allow a capillary to be joined to any of a variety of port members, including attachment to a port member of a moveable arm for the deposition of an array of spots on a surface. The moveable arm would allow placement of such spots in different locations. By including multiple capillary tubes within the ferrule, the connector member could mix compounds on a spot or could be attached to a receptacle for deposition of the reactants to be mixed.

### BRIEF DESCRIPTION OF THE DRAWINGS

FIG. 1 is a side view of two connector members and a fastener for the members according to the present invention.

FIG. 2 is a perspective view of a single connector member shown in FIG. 1.

FIG. 3 is an exploded perspective view of a connector member shown in FIG. 2.

FIG. 4 is an exploded perspective view of the fastener shown in FIG. 1.

FIG. 5 is a perspective view of the fastener member shown in FIG. 4.

FIG. 6 is a side cutaway view of an alternate embodiment of a single connector member joined to a fastener.

FIG. 7 is a perspective view of a portion of a ferrule for a connector member of the type shown in FIG. 1.

FIG. 8 is an end view of the ferrule shown in FIG. 7.

FIGS. 9a and 9b are schematic sectional views showing non-rotatable fibers at ends of rotatable ferrules of the type shown in FIG. 7 function as a valve.

FIG. 10 is a schematic sectional view showing ferrules of the type shown in FIG. 7 combined with a washer functioning as a manifold.

FIG. 11 is a schematic sectional view of two rotatable ferrules of the type shown in FIG. 7 functioning as a fluid router.

FIG. 11a is a schematic sectional view of two rotatable ferrules of the type shown in FIG. 7 functioning as a fluid router.

FIG. 12 is a plan view of a number of connector members of the type shown in FIG. 1 used for a macroscale injector injecting fluid through a microscale capillary tube.

FIG. 13 is a plan view of the injector of FIG. 12 with an additional connector of the type shown in FIG. 1 functioning as a fluid router.

FIG. 14 is a plan view illustrating a sample loading and unloading apparatus using connectors of the type illustrated in FIG. 1.

FIG. 15 is a plan view illustrating a nanoscale PCR apparatus using connectors of the type illustrated in FIG. 1.

FIG. 16 is a plan view illustrating a system with capillary electrophoresis and laser induced fluorescence to detect DNA using connectors of the type illustrated in FIG. 1.

FIGS. 17a-17e are schematic sectional views of ferrules with multiple fibers in closely packed geometric arrangements.

FIG. 18 is a perspective view of another embodiment of the capillary connector.

FIG. 19a is a perspective view of a capillary connector joined to the side of a microchannel containing substrate.

FIG. 19b is an exploded view of the connector of FIG. 19a.

FIG. 20 is a detail of the substrate edge of FIGS. 19a and 19b.

FIG. 21 is a detail of the end of a connector used in FIGS. 19a and 19b.

FIG. 22 is a perspective view of a capillary connector joined to the top of a substrate having microchannels.

FIG. 23 is an exploded view of the connector of FIG. 22.

FIG. 24 is a detail of the face of the substrate of FIGS. 22 and 23.

FIG. 25 is a capillary connector fitted against a substrate containing microchannels in a tray holder.

FIG. 26 is a top view of two joined connectors.

FIG. 27 shows the connectors of FIG. 26 separated.

FIG. 28 is a top view of a tray holding and joining the connectors of FIG. 26.

FIG. 29 is a variant of FIG. 28 having a fluid routing substrate positioned between the connector halves.

FIG. 30 is a variant fluid routing substrate.

FIG. 31 is a manifold substrate.

FIG. 32 is an alternative fluid routing substrate.

FIG. 33 is a side view of a multilayer connector substrate.

FIG. 34 illustrates the routing of fluid pathways using the connector of FIG. 29.

FIG. 35 is a side cutaway view of channel ends meeting in a connector.

FIG. 36 is a top view of two microfluidic chips connected face to face.

FIG. 37 is a cross-section of the connection of two microchannels from the embodiment shown in FIG. 36.

### BEST MODE OF CARRYING OUT THE INVENTION

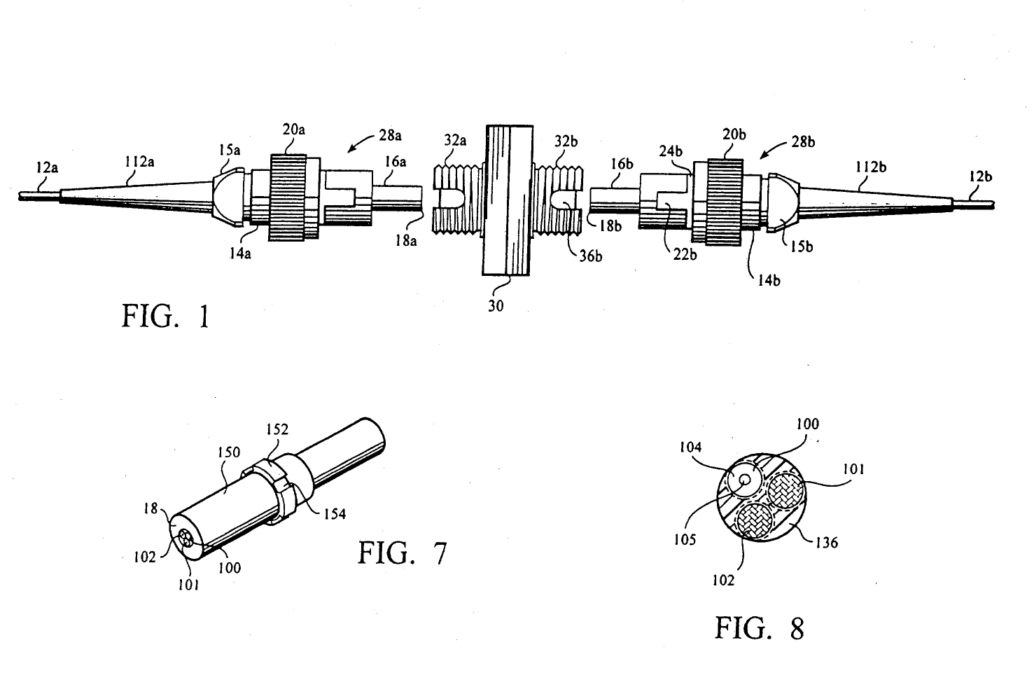

With reference to FIG. 1, a connector is adapted from a standard FC-style fiber optic connector, consisting of a first connector member 28a and a second connector member 28b joined by an adapter 30. The first connector member 28a has a first capillary 12a entering a ring 14a and extending into rotatable ferrule 16a. The capillary 12a is fixedly attached within rotatable ferrule 16a and terminates at end 18a of rotatable ferrule 16a. The end may be flat or, more typically, have a slight radius.

In a similar manner, in the second connector member 28b a second capillary 12b enters a ring 14b and extends into rotatable ferrule 16b. The capillary 12b is fixedly attached within rotatable ferrule 16b and terminates at end 18b of rotatable ferrule 16b.

An adapter 30 located between the two connector members 28a and 28b joins the two connector members. Rotatable ferrule 16b is mounted into externally threaded cylindrical protrusion 32b. The orientation of an internally threaded knurled nut 20b in relation to externally threaded cylindrical protrusion 32b is determined by key 22b extending from key ring 24b which is coaxial with capillary 12b. Key 22b fits into gap 36b in externally threaded cylindrical protrusion 32b. Knurled nut 20b is rotated about externally threaded cylindrical protrusion 32b to securely attach connector member 28b to adapter 30. In a similar manner, rotatable ferrule 16a is mounted into externally threaded cylindrical protrusion 32a. Knurled nut 20a is rotated about externally threaded cylindrical protrusion 32a to securely attach connector member 28a to adapter 30.

When connector members 28a and 28b are joined together, the ends 18a and 18b are pressed together within adapter 30. The capillaries 12a and 12b can then be brought into alignment if symmetrically affixed within ferrules 16a and 16b.

A ferrule 16a can terminate a set of one or more fibers. This set of one or more fibers can be a single capillary tube or can be a plurality of fibers, at least one of which is a capillary tube. The capillary tube is made of glass, silica, metal, polymer, or other materials. In the preferred embodiment, any non-hollow fibers included are fiber optic fibers or capillaries that have been plugged with material, such as epoxy.

Strain relief boots 112a and 112b are preferably included extending from and mounted within faceted heads 15a and 15b of knurled cylinders 20a and 20b to prevent mechanical stresses from bending or breaking the fibers contained within cylindrical sleeves 12a and 12b.

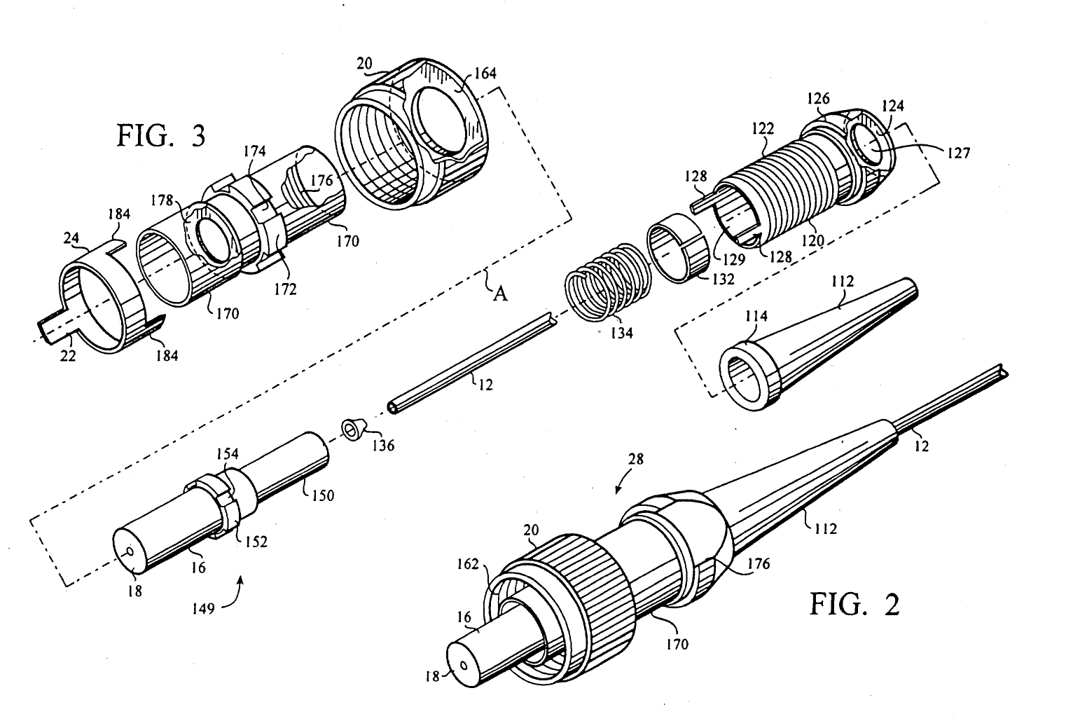

FIG. 2 shows a connector member 28 as assembled. A capillary 12 enters connector member 28 passing through strain relief boot 112, through connector 170 and terminating at end 18 of ferrule 16. Nut 20 is annularly disposed about connector 170.

FIG. 3 shows coaxial component parts for assembling one of the connector members 28a or 28b along an axis A. The strain relief boot 112 is inserted into an end of externally threaded hollow bolt 120. The annular exterior lip 114 of boot 112 is secured against the annular interior lip 124 of faceted head 15. Once boot 112 is inserted into bolt 120 a compression ring 132 is inserted into bolt 120 at opening 129 and slid to the head end of bolt 120. Compression ring 132 will fit tightly into bolt 120. Next spring 134 is slid into opening 129 of bolt 120 and rests on a shoulder inside of connector body 170.

Capillary 12 extends into head opening 127 of hollow bolt 120 and passes through bolt 120 and into ferrule 16. The capillary terminates at end face 18 of ferrule 16. Epoxy 136 holds the capillary 12 in place at the end face 18 of ferrule 16.

Ferrule 16 is typically a metal or ceramic cylindrical body having an axial hole into which the capillaries or fibers are secured in place. The ferrule is either press fit or epoxied into ferrule stem 150. Ferrule 16 has an outer diameter tolerance of minus zero, plus one micrometer. The hole is axially bored to an axial tolerance ranging between 2 to 15 micrometers, depending on capillary diameter and number of capillaries. The space between capillaries is filled with epoxy. The annular flange 152 is notched with notches 154. Four notches are disposed about annular flange 152 with each notch being equally separated.

Knurled nut 20 is fit over the assembly of hollow bolt 120. Hollow cylinder 170 is then fit over ferrule 150 and inserted inside knurled nut 20. An annular flange 172 on hollow cylinder 170 fits against annular interior lip 164 on knurled nut 20. Hollow cylinder 170 then extends over ferrule 150 with interior annular lip 178 forced against annular flange 152. Cylinder 120 is rotated onto the mating interior threads 176 of cylinder 170. As cylinder 170 is fully tightened down onto bolt 120, internal annular lip 178 is forced against annular flange 152 on ferrule 150 forcing the opposite side of flange 152 against spring 134. The tabs 128 extending from the rim of opening 129 on bolt 120 will fit into the notches 154 in annular flange 152, holding ferrule 150 rotationally secure. As cylinder 170 is fully tightened, spring 134 will compress, pressing against annular flange 152 and biasing ferrule 150 from within bolt 120 with about twenty grams of force.

A key ring 24 with a key 22 is fit over hollow cylinder 170 and the two prongs 184 fit into two of the six notches 174 disposed about annular flange 172.

Several methods exist for rotating the orientation of the ferrule. First, by rotating the ferrule assembly 149 one quarter turn, a new pair of notches 154 will align with prongs 128. This enables four different orientations of ferrule 150. In addition, by rotating key ring 24 in relation to cylinder 170 different notches 174 on annular flange 172 will align with ring prongs 184. The annular flange 172 has six notches 174 disposed about the flange. The enables six different orientations of the ferrule 150 position relative to the key 22.

In an alternative embodiment, key ring 24 is made without ring prongs 184, or the key ring 24 is not used. This would result in a cylinder that is may be freely rotated in the adaptor. By turning the hollow bolt 120, ferrule assembly 149, which is non-rotatably held within the assembly of hollow bolt 120 and hollow cylinder 170, would then also rotate, altering the orientation of the non-rotating end fibers epoxied into ferrule 150.

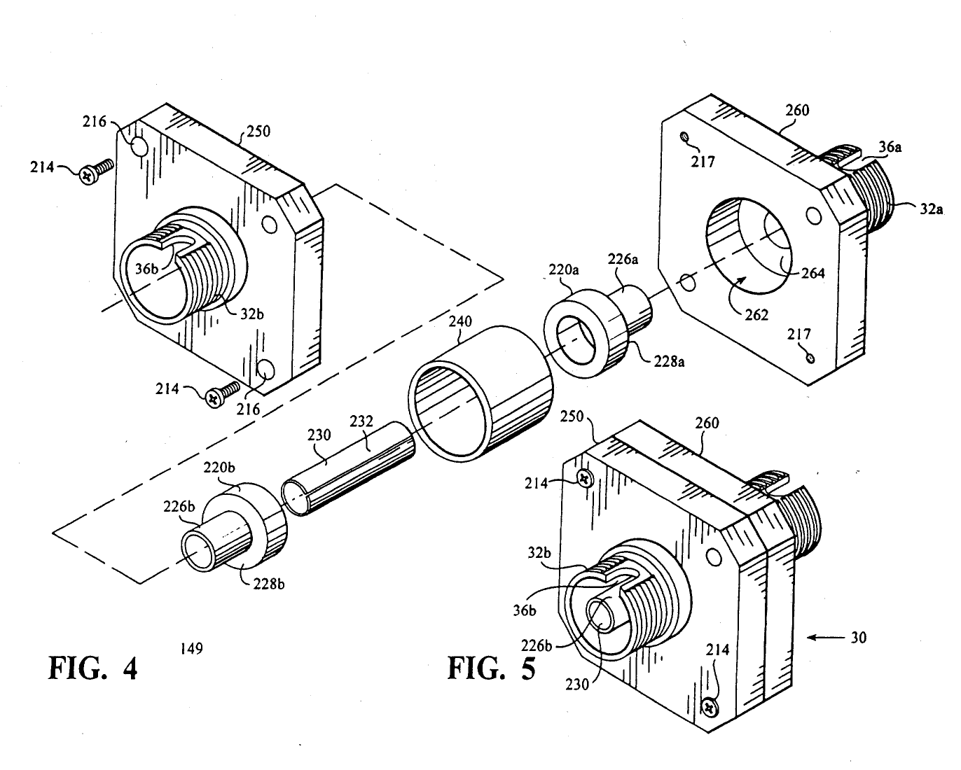

FIG. 4 shows the component parts for assembly of adapter 30. The rear faceplate 260 has a cylindrical indentation 262 and an annular lip 264. Rear hub 220a fits within rear faceplate 260 with the annular lip 226a on hub 220a fitting against lip 264 with hollow cylindrical protrusion 226a on hub 220a extending beyond the lip and into exteriorly threaded cylindrical protrusion 32a on rear face plate 260. Cylinder 240 coaxially aligns hub 220a and hub 220b. Into hollow cylindrical protrusion 226a of rear hub 220a split zirconia sleeve 230 is inserted, with sleeve extending to near the end of cylinder 226a, stopped at a lip therein. Front hub 220b fits into the other end of cylinder 240 and the other end of sleeve 230 fits into cylindrical protrusion 226b. Front face plate 250 fits to rear face plate 260. Cylinder 240 fits within front face plate 250 and cylindrical protrusion 226b extends through face plate 250 into cylindrical protrusion with exterior threading 32b. Screws 214 insert into holes 216 on front face plate 250 and screw into holes 217 on rear face plate 260.

FIG. 5 shows the assembled adapter 30. Screws 214 have been inserted through front face plate 250 to attach it to rear face plate 260. Alternatively, other forces may be applied to keep face plates 250 and 260 together. The face plates could be rounded to form a driven gear for rotation by a motor discussed below. Cylindrical protrusion 226b extends through face plate 250. Fitted within protrusion 226b is split zirconia sleeve 230. Sleeve 230 is a loose fit inside of hubs 220a and 220b. Exteriorly threaded cylindrical protrusion 32b extends from the center of the fastener.

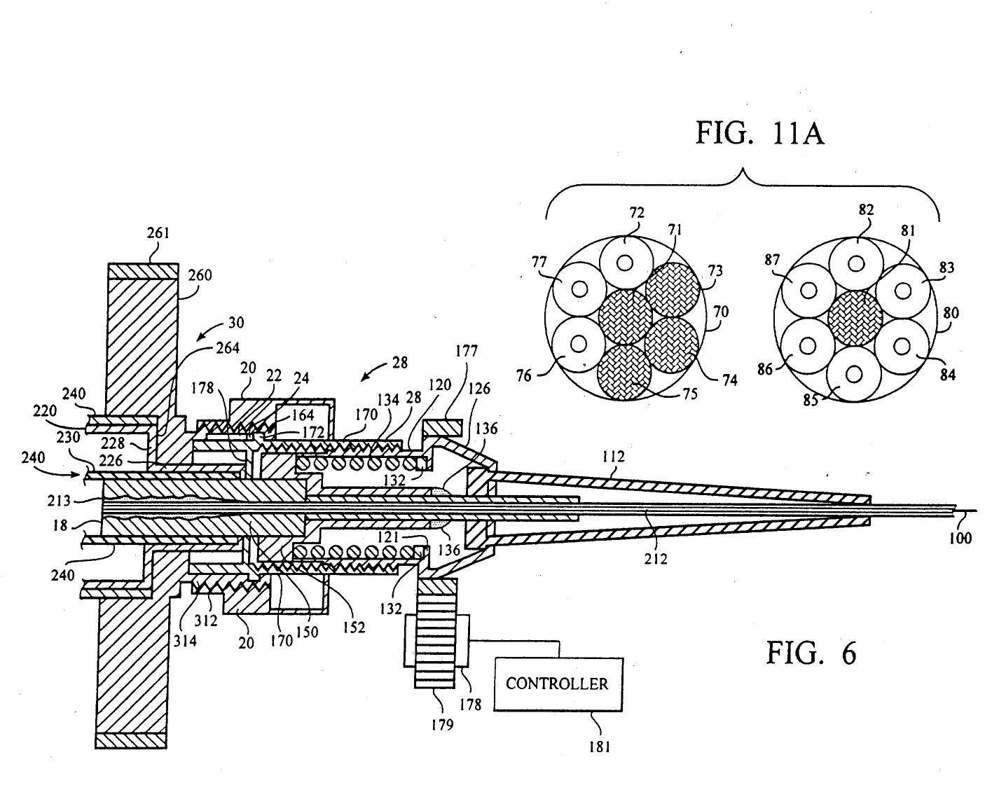

The fitting of adapter 30 with connector member 28 is shown in FIG. 6. In FIG. 6, a bundle of fibers 212, at least one of which is a capillary, enters the connector through stress relief boot 112 and proceeds into hollow bolt 120. The epoxy coating 213 is only one to a few microns thick. Within the hollow bolt 120, bundle of fibers 212 is attached within ferrule 150 by epoxy 213. The ferrule terminates at face 18. The end faces of the ferrules have a spherical shape, i.e. radiused, to further ensure a leakproof joint. A typical radius of curvature is 5-30 mm. By curving the end faces, the requirements for polishing the end faces are greatly reduced. The end faces are polished such that the central portion of the end face 18, containing the capillaries, comes in contact before the outer portion of the end face. This eliminates the need to polish a flat end face to 0Ε perpendicularity to the capillary. Non-zero degree end face polish would cause an air gap, leading to leakage.

Ferrule 150 has a circular annular flange 152, which is held against cylinder lip 178 and biased against lip 178 by spring 134. The spring is held in threaded cylinder 120 by compression ring 132. Compression ring 132 is held in place by annular bolt head lip 121.

Internally threaded cylinder 170 is screwed to hollow bolt 120. The interior of cylinder 170 has an annular lip 178 that holds circular flange 152 of ferrule 150. On the exterior of cylinder 170, an annular circular flange 172 abuts annular lip 164 of knurled nut 20. Nut 20 screws onto an exteriorly threaded cylindrical protrusion 32 on rear face plate 260.

On rear face plate 260, cylinder 240 is mounted annularly to hub 220 with hub lip 228 abutting rear face plate lip 264. Cylindrical protrusion 226 extends through rear face plate 260. Mounted within cylindrical protrusion 226 is split zirconia sleeve 240. Zirconia sleeve 240 acts as a spring to align outer diameters of ferrules 150. Inside zirconia sleeve 240 frictionally fits ferrule 150 with the bundle of fibers 212. With nut 20 tightened as shown, the connector member and fastener are securely attached together, and the spring is compressed, thereby compressing end faces, creating a leakproof joint. Typical spring force when fully assembled is two pounds.

A stepper motor 178 may be used to rotate a gear 179, turning meshing gear 177 to rotate ferrule 150 through external teeth on a fully round nut 126 or on a round adapter member 260 having external gear teeth 261, which may be moved by a gear 179. Motor 178 may operate under control of an automatic controller 181 which is programmed to achieve desired valve settings at desired times. The controller allows selectable alignments of a first ferrule relative to a second ferrule.

With this basic connector, a number of uses become possible. As mentioned above, the bundle of fibers 212 contains at least one capillary tube. In one embodiment of this invention, each of the two abutting ferrules of a connector contain three fibers. By rotating these two ferrules in relation to each other, the fibers within the ferrule would be brought into or out of alignment. A non-hollow fiber, typically a plugged capillary tube, could be brought into alignment with a capillary tube, effectively blocking flow through the tube. This would allow the connector to act as a switch. By having one member of the connector contain a bundle of fibers having multiple capillary tubes and the second member contain a bundle of fibers with one capillary, a 3-to-1 fluid router is formed. If a channeling device is located between a ferrule containing multiple capillary tubes and a ferrule containing a single capillary tube, a manifold is formed. Finally, the connector can be used as an interface between macroscale devices and microscale capillary tubes.

FIG. 7 shows a rotatable ferrule 150. The ferrule is adapted from a FC-style fiberoptic connector. At tip 18 of ferrule 150 the ends of three fibers are seen. These fibers are a capillary tube 100 and two fiber optic fibers, 101 and 102. The capillary and the fibers should have the same outside diameter for closest packing. To adapt the invention from the FC-style connector, a FC-style connector is modified by precision drilling of the ferrule to produce a hole within a few microns of the size of the bundle of fibers. Within a FC-style connector, the bundle of capillaries can contain a single capillary, three capillaries, seven capillaries (packed with one central capillary and 6 radial capillaries), or nineteen capillaries (packed with twelve capillaries surrounding six capillaries surrounding one capillary), or any symmetrical arrangement of fibers or capillaries. Any of the capillaries can be replaced with either a plugged capillary or a fiber optic fiber of equal outside diameter.

To make a three fiber FC-style connector, the hole of a FC-style connector is drilled to accommodate the exterior diameter of a bundle of three fibers. The three-fiber bundle is inserted and centered where the bundle consists of three capillaries, the capillaries are inserted and secured in place with epoxy with the ends of the capillaries protruding from the face of the ferrule. The end of the capillaries is then polished back with a slight radius.

FIG. 8 shows the end of a ferrule after one unplugged capillary and two plugged capillaries have been inserted and secured in place. A band of epoxy 136 extends axially and secures the capillary tubes in place. A capillary tube 100 with an interior bore 105 and two plugged capillaries 101 and 102 terminate at the end of the ferrule 18. The material comprising the unplugged capillary tube 100 and the plugged capillaries 101 and 102 has been polished back with a slight radius.

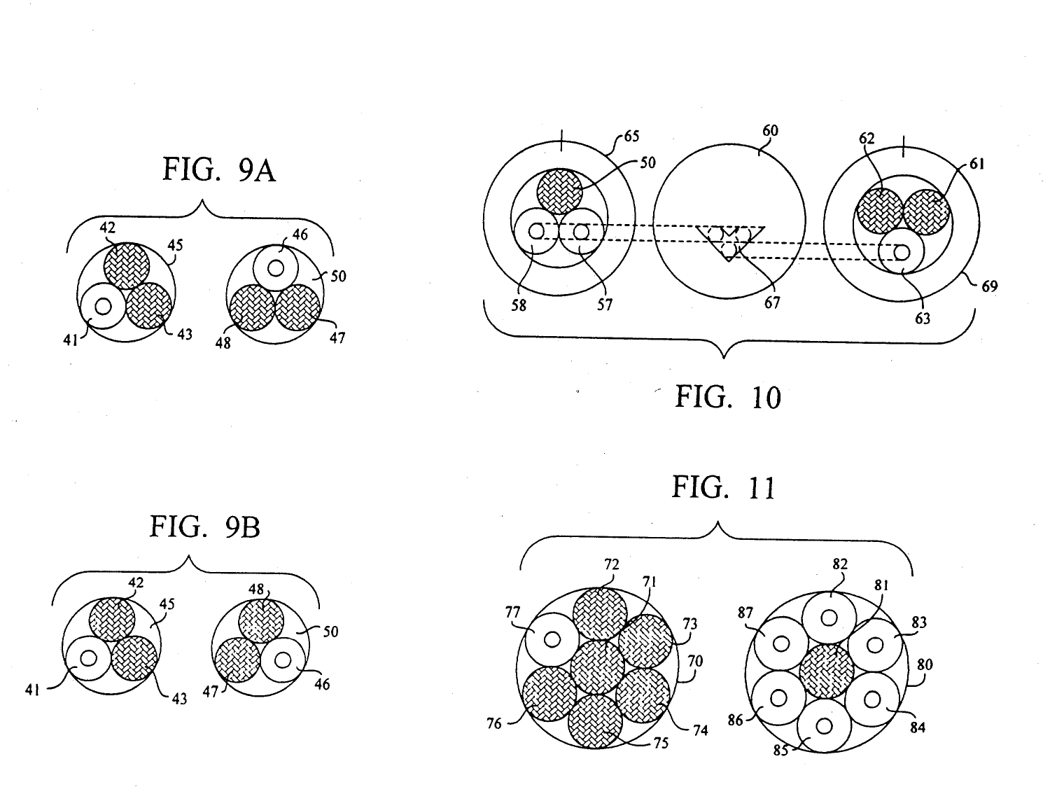

This basic embodiment of this invention is readily useable as a zero dead-volume slide valve. A schematic for the connector performing this function is shown in FIGS. 9a and 9b. FIG. 9a shows a representation of the connector when closed. A first ferrule section 45 and a second ferrule section 50 are shown. In the connector, fiber ends, i.e. capillaries, would be in facing alignment and biased against each other in the fastener of the connector. Both of the sets of fibers within the ferrule are offset from the center and precisely mounted with a standardized orientation on the ferrule. This is effected such that plugged capillary 42 in ferrule section 45 could align with capillary tube 46 in ferrule section 50. In a similar manner, plugged capillary 43 in ferrule section 45 would align with plugged capillary 48 in ferrule section 50 and capillary tube 41 in ferrule section 45 would align with plugged capillary 47 in ferrule section 50. Because the two capillary tubes are aligning with non-hollow fibers, no fluid would be able to pass through either of the capillaries and all capillaries in this valve would be closed.

The valve could be opened by rotating ferrule section 50 with a one-third turn. This results in the orientation shown in FIG. 9b. Now capillary tube 41 in ferrule section 45 would align with capillary 46 in ferrule section 50. Fluid would then be able to flow through from one capillary to the other. Plugged capillaries 42 and 43 in ferrule section 45 would align with fibers 48 and 47 in ferrule section 50 respectively.

The methods of rotating the ferrules were set out above. When the ferrule is rotated, there needs to be some indication of the alignment of the fibers within the sleeve. This would allow the user to determine if the valve was in an open or closed position.

A first indicator of the orientation of the fibers within a sleeve would be to use markings or notches on hollow cylinder 120. The marking could be located near the end 15 of hollow bolt 120.

When two members of the connector are secured together, the markings on the two cylinders of the two members could indicate the orientation of the fiber bundles secured within the connector. This would indicate the orientation of the fibers located inside the bundles.

A second method of determining alignment would be through the use of optical properties of the fiber optic fibers. By including a fiber optic fiber in each side of the connector, the fiber optic fibers could act as an alignment indicator. Within the bundles, the fibers would be arranged such that when the fiber optic fibers were in alignment the capillary tubes would also be in alignment. By attaching the distal end of a fiber optic fiber contained within one bundle to a light source and attaching the distal end of a second fiber optic fiber contained within the second bundle to a light detector the fiber optic alignment indicator would be enabled. When light is provided to the distal end of one fiber and is detected at the distal end of the second fiber this indicates that the fiber optic fibers are precisely aligned. The capillary tubes that are in a fixed relation to the fiber optic fibers would then also be aligned. This alignment system would be very highly accurate because the light would only pass through the fiber optic fibers only if they were precisely aligned.

The simplest example of a manifold would be a connector that channels the contents from two capillary tubes to one capillary tube. One embodiment of this system is shown in FIG. 10. A first ferrule 65 contains two capillary tubes 57, 58 and one plugged capillary 56. The second ferrule 69 contains one capillary tube 63 and two plugged capillaries 62 and 61. A washer 60 is located between the two ferrule ends 65 and 69. The cut out 67 of the washer 60 would be in the shape of a V with the width of each leg of the V as wide as the diameter of the inner bore of the capillary tube with the greatest bore width.

When the manifold is assembled, ferrule end 65 is aligned end to end with ferrule end 69 with washer 60 located between the two sleeve ends. The two capillary tubes 57 and 58 funnel fluid into the top of the V in cut out 67 and the fluid would flow down into the point of the V where the single capillary 63 would receive this flow. In this manner the fluid in two tubes would be combined into a single tube.

The washer can be adapted to combine more than two tubes. Additional legs could be added to channel the fluid from a greater number of tubes into a single tube or multiple tubes in an opposing ferrule.

An alternative means to achieve the manifold function can be realized by recessing the ends of the capillary tubes in one ferrule from the end of that ferrule. The fluid would exit the capillary tubes and be pressure driven to the inner bore of the other capillary.

A schematic of the connector functioning as a fluid router is shown in FIG. 11. Two ferrule sections 70 and 80 are shown. Ferrule 70 contains a plugged capillary 71, and six radial fibers 72-77. One of the radial fibers is a capillary tube 77, the others are five plugged capillaries 72-76. Ferrule 80 contains a central plugged capillary 81 and six radial fibers 82-87. All of the radial fibers are capillary tubes. When the capillary tubes are of the same diameter, close packing is possible and highly recommended. For this reason, plugged capillaries are preferred to optical fibers; namely, size matching is easier for open and plugged capillaries. Close packing of fibers on opposite sides of a valve leads to good fluid communication between opposite sides of a valve, without leakage or cross-contamination and aids in alignment of opposing capillaries.

As initially shown, the single capillary tube 77 in ferrule 70 is aligned with capillary tube 83 on ferrule 80. This allows fluid communication between the two capillary tubes 77 and 83. The other ends of capillary tubes 82, 84-87 in ferrule 80 would be blocked by plugged capillaries 72-76. Ferrule 80 could then be rotated by 1/12 of a turn clockwise. This would align capillary 77 in between capillaries 87 and 82 and would act as a closed valve for all positions. Ferrule 80 could then be rotated by a further 1/12 turn clockwise. This would align capillary tube 77 in ferrule 70 with capillary tube 82 in ferrule 80. Fluid communication between capillary tube 77 and capillary tube 82 is now possible. All the other capillary tubes in ferrule 80 are blocked by plugged capillaries in ferrule 70. By further subsequent rotations of ferrule 80 each of capillaries 82-87 could be brought into fluid communication with capillary 77 in ferrule 70.

With reference to FIG. 11a ferrule 70 is seen to contain plugged capillaries 71, 73, 74 and 75. On the other hand, capillary tubes 72, 76 and 77 are each open and may carry different reagents or samples. Ferrule 70 abuts ferrule 80 which has one plugged capillary 81 and open capillaries 82, 83, 84, 85, 86 and 87. When ferrules 70 and 80 are brought into an abutting relationship, the three capillaries 72, 76 and 77 and ferrules 70 may distribute fluid among the six capillaries in ferrule 80 by selective rotation of ferrule 70 with respect to ferrule 80.

### EXAMPLES

It will be readily apparent to those skilled in the relevant arts that other suitable modifications and adaptations to the methods and applications described herein are obvious and may be made without departing from the scope of the invention or any embodiment thereof. Having now described the present invention in detail, the same will be more clearly understood by reference to the following examples, which are included herewith for purposes of illustration only and are not intended to be limiting of the invention.

### Example 1

Injector

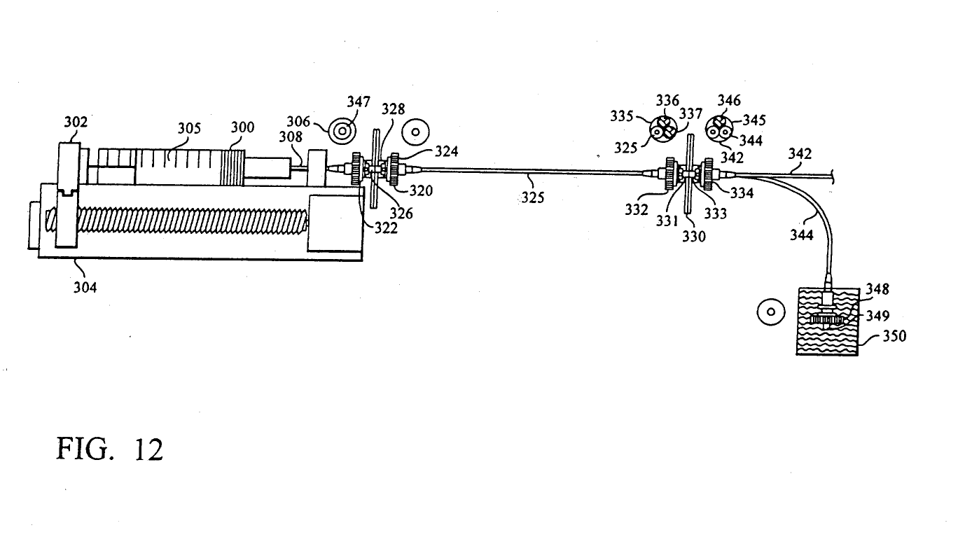

As is illustrated in this example, the connector described above is adaptable for acting as an interface between macroscale devices, such as syringe pumps or injectors and microscale capillary tubes. FIG. 12 shows an injector apparatus. In this drawing, the connectors are pictured with the fastener cut away to reveal the interior of the associated ferrules. Representations of the ferrule face are pictured above each connector member.

In this embodiment, the injector is comprised of syringe 300 with a plunger 302 controlled by controller 304. The needle 308 of the syringe 300 terminates in ferrule 326 of connector member 322. A representation of the end of the ferrule 306 shows that the end of the needle 347 is a macroscale tube of up to 1 mm in diameter. The second connector member 324 contains a single microscale capillary tube 325. Capillary tube 325 extends from second connector member 324 and the opposite end of the length of capillary 325 terminates in ferrule 331 of connector member 332. Ferrule 331 contains a triplet packing of fibers shown in icon 335 which shows the capillary tube 325 and two plugged capillaries or fiber optic fiber ends 337 and 336. Ferrule 331 is in alignment with ferrule 333 of connector member 334. Ferrule 333 also contains triplet packing of fibers shown in icon 345. Terminating at the face of ferrule 333 are three fibers, capillary tube 344, capillary tube 342 and plugged capillary 346. Ferrule 333 would be rotated such that the bores of capillary tube 325 and capillary tube 344 were in alignment. Capillary tube 344 terminates at ferrule 349 attached to the optional connector member 348. This member is mounted on reservoir 350 with the capillary tip submerged.

The controller 304 could withdraw plunger 302 forming a vacuum that would draw fluid from reservoir 350 through capillary tube 344 through capillary tube 325 and into barrel 305 of syringe 300.

Sleeve 333 could then be rotated such that the inner bore of capillary 342 was aligned with the inner bore of capillary tube 325. Controller 304 then can depress plunger 302 forcing fluid through needle 308, into capillary tube 325 and into capillary tube 342. This system allows injections of determined amounts of fluid to be introduced into a flow stream.

### Example 2

Injector with Fluid Router

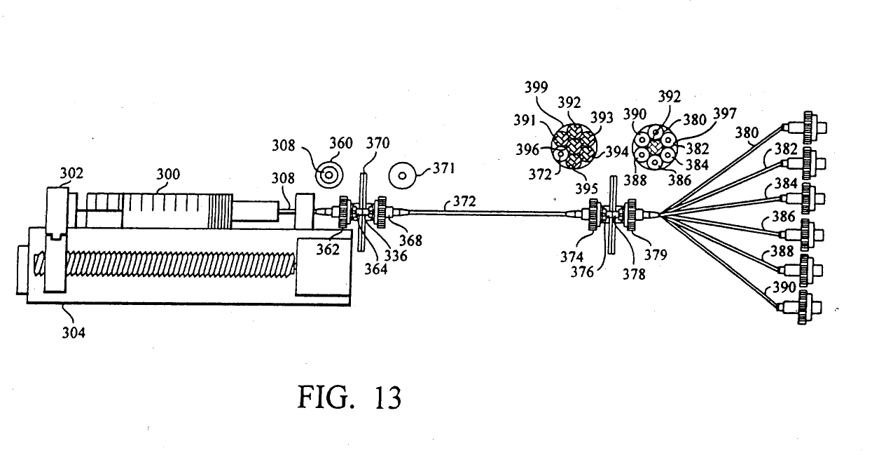

Once the basic injector has been developed, the connector members allow for a number of expanded functions. FIG. 13 demonstrates how the previously described injector can be expanded to include a fluid router. Like the previous apparatus, a controller 304 operates a syringe 300. The controller can depress plunger 302 forcing fluid into needle 308. Needle 308 terminates at ferrule 364 of connector 370. Fluid is transferred into capillary tube 372 located in ferrule 336.

The distal end of capillary tube 372 terminates at ferrule 376. The end of ferrule 376 is pictured at icon 395. Capillary tube 372 is the sole capillary tube within the bundle of fibers in ferrule 376. The bundle contains 7 fibers, with one fiber surrounded by six other fibers. Capillary tube 372 is packed with plugged capillaries 391-396. Ferrule 376 is in alignment with ferrule 378. Ferrule 378 also contains 7 fibers, a central plugged capillary 392 around which is packed six capillary tubes, 380, 382, 384, 386, 388, and 390. As pictured, capillary tube 372 in ferrule 376 is in alignment with capillary tube 384 in ferrule 378. All the other capillary tubes in ferrule 378 are blocked by the plugged capillaries in ferrule 376.

By rotating ferrule 376 one-sixth turn counter-clockwise, capillary tube 372 would be aligned with capillary tube 386. By performing subsequent one-sixth rotations of ferrule 376, capillary tube 372 could sequentially be brought into fluid communication with each of the six capillary tubes in ferrule 378. Thus the fluid from syringe 300 could be directed to any of six capillary tubes affixed within ferrule 378. The capillary tubes contained within ferrule 378 then could be connected to a variety of analytical equipment. One or more of the capillary tubes could be connected to a reagent or wash reservoir. This injector could withdraw liquid from a reservoir attached to one of these lines and then could route the fluid into the other capillary tubes.

### Example 3

Sample Loading and Unloading

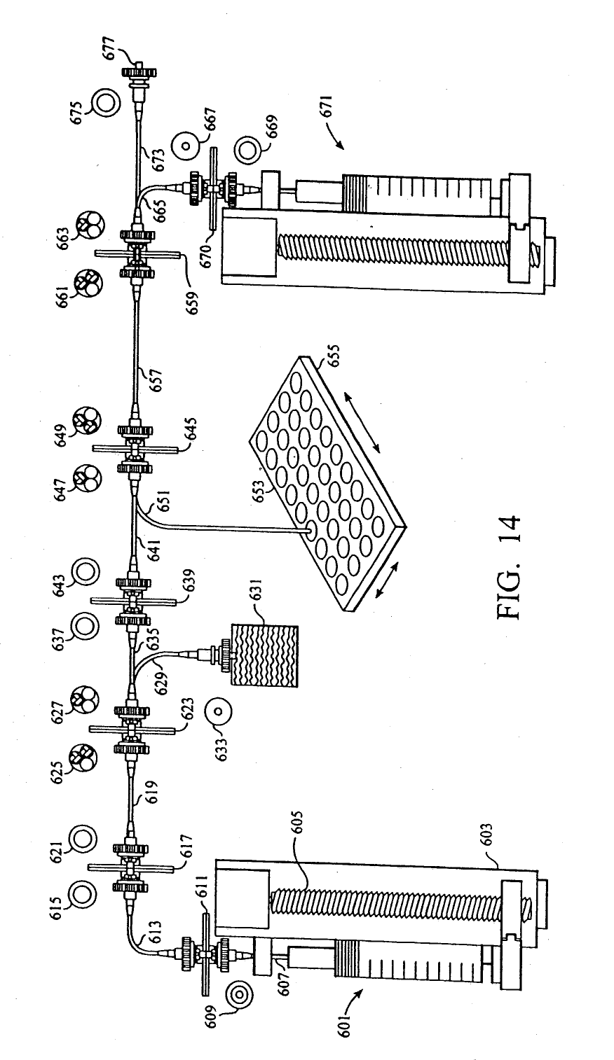

With reference to FIG. 14, a first automated syringe pump 601 is operated by a microstepper motor 603 controlled by an electronic controller, not shown, driving a very fine screw 605 linked to the plunger of the syringe. The syringe has a barrel 607 whose cross section is shown by the icon 609 and is connected to adapter 611. The opposite side of the adapter 611 is connected to a first capillary storage section 613 having a known volume. This storage section is optional. The cross section of the storage capillary is shown by the icon 615. The capillary storage section is connected to an adapter 617 which links the first capillary storage section to a second capillary storage section 619 whose cross section is shown by the icon 621. The second capillary storage section, like the first section, has a known storage volume. The capillary storage section is bundled with two fibers which are plugged capillaries, as indicated by icon 625, showing the cross section of the three fibers, one of which is unplugged and is the capillary 619. The three fibers are linked to adapter 623 in the manner previously described with reference to FIG. 1, forming a first two-to-one branching valve 623. The output side of the branching valve has a cross section shown by icon 627 with two unplugged capillaries and one plugged capillary. One of the branches is capillary 629 having a cross section indicated by icon 633 and leading to a fluid reservoir 631. This reservoir contains a supply reagent, which is to be injected into the system using the first syringe pump 601. The second output member of the branching valve 623 is the capillary storage section 635 having a cross section indicated by icon 637 and joined to adapter 639. Once again the capillary storage section 635 holds a known volume of fluid which may be pumped to other sections.

The adapter 639 joins a fourth storage capillary, having a cross section indicated by icon 643 to a second two-to-one branching valve 645 having an input section indicated by the icon 647. The icon 647 shows one plugged capillary section and two unplugged sections. One of the unplugged sections is the storage capillary 641 while the other is a capillary 651 in order to communicate with a plurality of wells 653 in the movable microtiter plate 655. The microtiter plate moves in X, Y and Z directions to bring the wells 653 into fluid communication with the tip of capillary 651. The output of the branching valve 641 is a fixed volume storage capillary 657, which is connected to a two-to-one branching valve 659. The output of the two-to-one branching valve 645 has a cross sectional shape indicated by the icon 649, with two plugged capillaries and one open capillary. Icon 661 has a similar configuration for the input side of branching valve 659. On the other hand, the output side of branching valve 659 has two open capillaries and one plugged capillary, indicated by icon 663. One of the capillaries 665 leads to the second syringe pump 671 via an adapter 670 with the input side having a cross sectional shape indicated by icon 667 and an output capillary having a cross sectional shape indicated by icon 669. The output is affixed to the barrel of the second syringe 671. The second output of valve 659 is a capillary of known volume 673, which terminates in a ferrule 677 which is linked to the main process flowstream which utilizes samples which have been loaded onto the microtiter plate 655 and then unloaded.

As may be seen from FIG. 14, samples may be drawn from reservoir 631 and pumped in known volumetric quantities by the first automated syringe pump 601 into storage capillaries 613, 619, 635, 641 and 657. The portion of sample in 657 may be pumped by means of the second pump 671 into capillary 651 for loading of the microtiter plate 655.

In withdrawing sample from the microtiter plate, the second pump 671 may be used to draw sample from a well to the storage capillary 657 and then the first pump used to push sample into the storage capillary 673 for advancement into the main process stream. In this manner, samples may be loaded from the microtiter plate and then withdrawn by the push-pull action of the first and second pumps. Alternatively, samples could be deposited into a microtiter plate, onto the surface of a microarray, or into a microchip for further processing or analysis.

An alternate embodiment can use a series of pairs of valves, such as 645 and 659, with a series of sampling capillaries, i.e. 651, to produce a series of samples if each pair of valves is separated by a capillary of fixed length. In an extension of this embodiment, the second pump 671 could use a fluid router, as shown in FIG. 13, to sequentially or simultaneously withdraw multiple samples from a microtiter plate or other source of sample. This will increase throughput for high throughput applications.

### Example 4

Nanoscale PCR

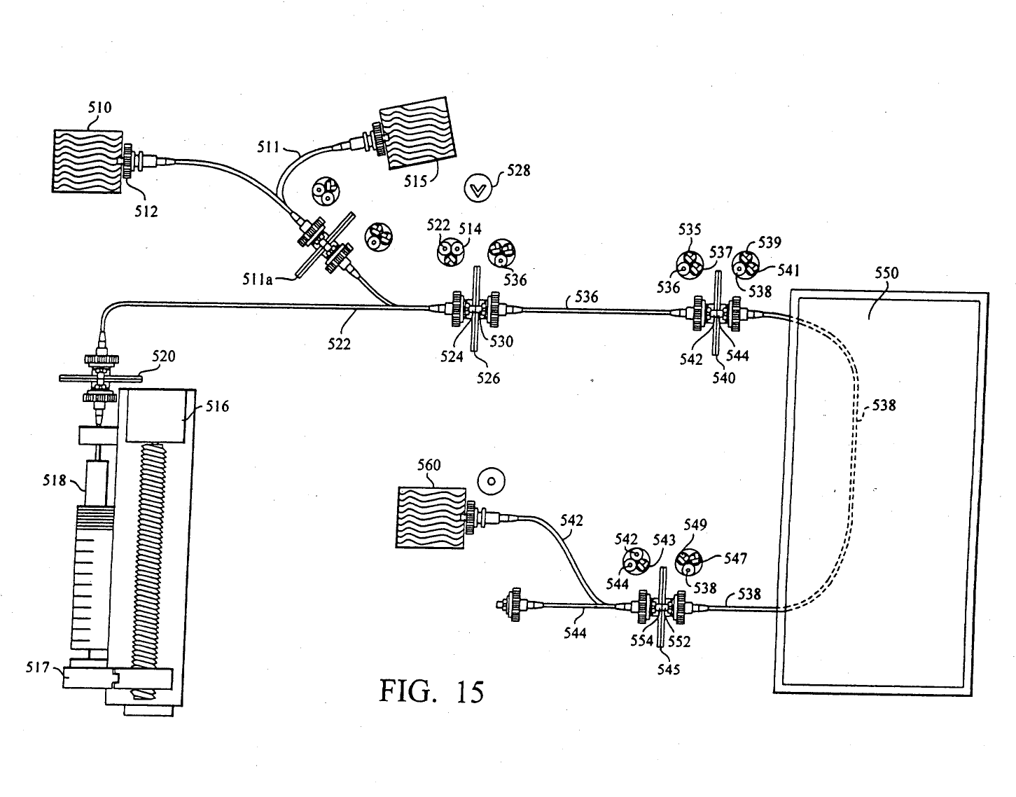

The system described with reference to FIG. 15 can be utilized to create a system for performing the polymerization chain reaction on a nanoscale level requiring as little as a few microliters total reaction volume. Although this example shows PCR for a single DNA sample, the apparatus may be combined with the apparatus of the prior example so that multiple samples can be handled. While this example shows an implementation for PCR, alternate embodiments are applicable to other biochemical and chemical reactions, including those that use only a single temperature.

The basic idea for a nanoscale reaction system is adaptable to executing biochemical and chemical reactions on a very small scale. To perform this reaction, the length of capillary would be encased within a thermocycling heat pump. The capillary tubes connecting into the length of capillary tube could deliver reagents for the polymerization chain reaction (PCR) in one of the input capillary tubes and a sample of DNA in the other input capillary. These would be combined into the single length of capillary tube and the two ends of the tube would be closed. The polymerization chain reaction would then take place as the thermocycling apparatus would then undergo the multiple cycles of timed temperature changes required for the reaction. The following description defines a device for executing this procedure.

The PCR reaction requires combination of two fluids, the PCR reaction mixture and the DNA sample. In this system, the PCR reaction mixture, containing the DNA polymerase, nucleotides, and a buffer mixture would be contained in pressurized reservoir 510. Adapter 512 is fastened onto the side of reservoir with adapter 512 bringing capillary tube 514 into fluid communication with the fluid in reservoir 510.

The DNA sample could be introduced through use of an injector. Injector syringe 518 would be automatically controlled by a motor 516 driven by a controller that would actuate the injector by depressing the plunger 517, introducing samples of DNA into the reaction mixture. Adapter 520 would act as an interface between macroscale syringe 518 and microscale capillary tube 522.

Capillary tube 514 and capillary tube 522 would terminate at ferrule 524 on adapter 526. The second member of adapter 526 contains ferrule 530. Between the ends of ferrule 524 and ferrule 530 is washer 528, shown in a sectional icon. Washer 528 has a V shaped cut out. The inner bores of capillary tube 514 and capillary tube 522 align with the top legs of the V shaped cut out. The inner bore of capillary tube 536 aligns with the bottom of the cut out. The pressure from pressurized reservoir 510 and injector 518 would drive the fluids through the system and into capillary tube section 536.

Capillary tube 536 has a distal end that terminates at ferrule 542. Affixed within ferrule 542 is a set of three fibers, capillary tube 536 and two plugged capillaries, 535 and 537. Ferrule 542 is in facing alignment with ferrule 544. Inside ferrule 544 is affixed capillary tube 538 and plugged capillaries 539 and 541. When properly oriented, the end of capillary tube 536 and the end of capillary tube 538 are in alignment and fluid can flow from into tube 538. At the opposite end of capillary tube 538 is adapter 545. Capillary 538 terminates at ferrule 552. Affixed within ferrule 552 is capillary 538 and two plugged capillaries 549 and 547. Aligned facing ferrule 552 is ferrule 554. Ferrule 554 contains two capillary tubes, 544 and 542 and one plugged capillary 543.

After capillary tube 538 is filled with the reaction mixture and DNA sample, ferrule 542 can be rotated one-third turn, which will align the relatively non-rotating ends of capillary 536 with a plugged capillary 541. The second end of capillary tube section 538 can also be sealed by rotating ferrule 554 until plugged capillaries 549 and 547 block capillary tubes 542 and 544 and plugged capillary 543 blocks capillary tube 538. Capillary tube 538 would then be sealed on both ends. Chemistry could then be performed in capillary tube 538. Capillary tube section 538 is encased within thermal cycling apparatus 550. Apparatus 550 would then undergo temperature cycles to affect the polymerase chain reaction. When the reaction had completed, ferrule 542 could be rotated to again have capillary tubes 536 and 538 align. Ferrule 554 could be rotated so that capillary 538 aligned with capillary 544. The contents of the reaction tube could then be pumped from capillary tube 538 into capillary tube 544 which could lead to a DNA analysis apparatus. After capillary tube 538 had been emptied, ferrule 554 could be again rotated to align capillary tube 538 with capillary tube 542. At the same time, capillary 511 is aligned with capillary 514 and capillary 536 and capillary 538 through adapters 511a, 526 and 540. Capillary tube 542 leads to wash solution reservoir 560. Applying pressure on reservoir 560 will flush the reaction capillary 538, as will capillaries 536 and 514, into waste container 515 via capillary 511.

### Example 5

Capillary Electrophoresis DNA Detection

The capillary tubes described in the present invention are adaptable to equipment for the separation and analysis of chemicals and biopolymers, such as nucleic acid sequences. In FIG. 16, one embodiment of this system is shown. Although this example shows capillary electrophoresis for a single sample, the apparatus may be combined with the apparatus of Example 3 so that multiple samples could be handled. While this example shows capillary electrophoresis, alternate embodiments encompass other separation methods, such as microbore high pressure chromatography, gas chromatography, ion chromatography and mass chromatography.

The first step in this process requires filling a capillary tube with a separation matrix. The separation matrix is kept in a pressurized reservoir 430 connected by adapter 433 to capillary tube 432, having a cross-section 432a shown in the icon above adapter 433. The end of this capillary tube is brought into fluid communication with capillary tube 438. The matrix will then flow through sample injection capillary tube 490 which is aligned with the capillary tube 438 to the end of the tube which is aligned with the end of capillary tube 444. See the cross sections near ferrules 443 and 445, as well as near ferrules 475 and 485. The opposite end of this tube 444b is aligned with an end of capillary tube 466, which conducts the displaced contents of tube 466 to a waste receptacle 467. See cross sections 444b and 466a near ferrules 455 and 457, respectively.

After capillary tube 444 has been filled with the separation matrix, the DNA sample and denaturant are moved into sample injection capillary 490. Syringe 412 controlled by controller 410 injects a fluorescently labeled DNA sample into capillary tube 414. Denaturant is introduced through capillary tube 416. The ends of these two tubes, corresponding to cross-sections 414a and 416a, terminate at ferrule 415. Abutting ferrule 415 is ferrule 417 containing single capillary 422. Between ferrules 415 and 417 is a washer 420 with a V shaped cut out. Fluid from capillary tube ends, corresponding to cross sections 414a and 416a, flow into the legs of the V and are combined at the point of the V into an end, corresponding to cross section 422a, of capillary tube 422. An alternative embodiment uses a ferrule with capillary tubes 414a and 414b recessed, as described. The sample and denaturant then flows through capillary 422 to ferrule 443 which has been rotated such that end 490a is aligned with end 422b of capillary tube 422 and the combined DNA and denaturant mixture are loaded into sample loading capillary 490. Ferrule 475 terminates capillary 490 and abuts ferrule 485 associated with separation capillary 444 and waste delivery capillary 497. When the sample injection capillary 490 is loaded, capillary end 490b is aligned with capillary 497a. Excess sample may be diverted into waste container 498 through waste capillary 497 from ferrule 485. If pressure injection is desired, the sample in the loading capillary 490 may also be advanced by pressure into separation capillary 444 toward ferrule 455, which, together with ferrule 457, is open to capillary 466 in communication with the waste reservoir 467. Icons 494 and 496 indicate that the loading capillary 490 may be switched between the reaction capillary 444 and a waste delivery capillary 497, leading to waste reservoir 498.

With the DNA sample and denaturant loaded into capillary tube 490, the sample is ready to be electrophoretically separated. Ferrule 443 is rotated so that end 490a aligns with end 442b of capillary tube 442. Ferrule 475 is rotated so that the loading capillary 490 communicates through ferrule 475 to the separation capillary 444 through ferrule 485. End 442a contains an electrode 440 in a reservoir 492 for introducing electric potential, i.e. voltage, into the capillary tube. The reservoir 492 is filled with a matrix which contains a conducting buffer, such as TBE (Tris, Boric acid, EDTA). At the other end of capillary tube 444, end 444b is aligned with end 464a of tube 464. This tube is also filled with a conducting buffer and terminates an electrode 470. Current will then flow from electrode 440 to electrode 470 through the buffer in capillary tube 442, through the denatured DNA sample in loading capillary 490, through the matrix in capillary tube 444 and then pass through the buffer in capillary tube 464 and into the electrode 470. The DNA will migrate through the separation matrix, with the smaller DNA fragments moving more quickly than the larger DNA fragments. DNA fragments, as they are moved by the voltage will be drawn past laser induced fluorescence apparatus 460. This apparatus provides laser light of a known frequency perpendicular to the DNA stream, causing the labeled DNA to fluoresce. The fluorescence is then detected by a detector.

After the separation and detection are complete, the sample loading capillary 490 may be purified with fluid from a wash reservoir 436 flowing under pressure through ferrule 437, through capillary 438, into loading capillary 490 and then to the waste delivery capillary 497, flowing into waste reservoir 498. Similarly, any remaining fluid in capillary 444 may be diverted through ferrules 455 and 457 into waste reservoir 467. To load another sample, the loading capillary 490 is configured by alignment of ferrules 445, 443, 417 and 415 to receive fluid from sample capillary 414. An experiment may now proceed as previously described.

To replace the matrix after an experiment or series of experiments, ferrule 457 is rotated to have end 444b of capillary tube 444 align with end 466a of capillary tube 466. Ferrule 475 is rotated so that the end of capillary tube 490b aligns with end 444a of capillary tube 444. Ferrule 443 is rotated so that the end of capillary tube 490a aligns with end 438b of capillary tube 438. Ferrule 437 is rotated so that the end of capillary tube 438a aligns with end 434b of capillary tube 434. The other end 434a of capillary tube 434 is in fluid communication with wash solution in pressurized wash reservoir 436. Wash solution would then be driven through capillary 434, through capillary 438, through capillary 490, through capillary 444, and into capillary tube 466 where it would be transferred into waste reservoir 467. After washing of the matrix from the capillary tubes, the matrix could be refilled, as described above.

From the above description, it may be seen that the capillary valve, connector and router of the present invention provide a method for performing chemical reactions. The above examples shows that reactants for a chemical reaction or measurement may be placed in a plurality of capillary tubes having ends which terminate in a closely spaced pattern within a first ferrule. The opens ends of the tubes face in the same direction. Selected reactants may be merged into a single reaction capillary, which is movable among the plurality of capillary tubes. The reactants can be combined by moving the reaction capillary tube among the various capillary tubes among the plurality of tubes. Alternatively, a flow conduit defined in a washer or the like placed between the plurality of capillary tubes and the single tube may provide the desired flow channel. If the plurality of capillary tubes is arranged in a first ferrule and the single capillary tube is in a second ferrule, abutting the first ferrule, movement of one ferrule with respect to the other will bring the single capillary tube into selective communication with desired capillaries among the plurality of capillary tubes.

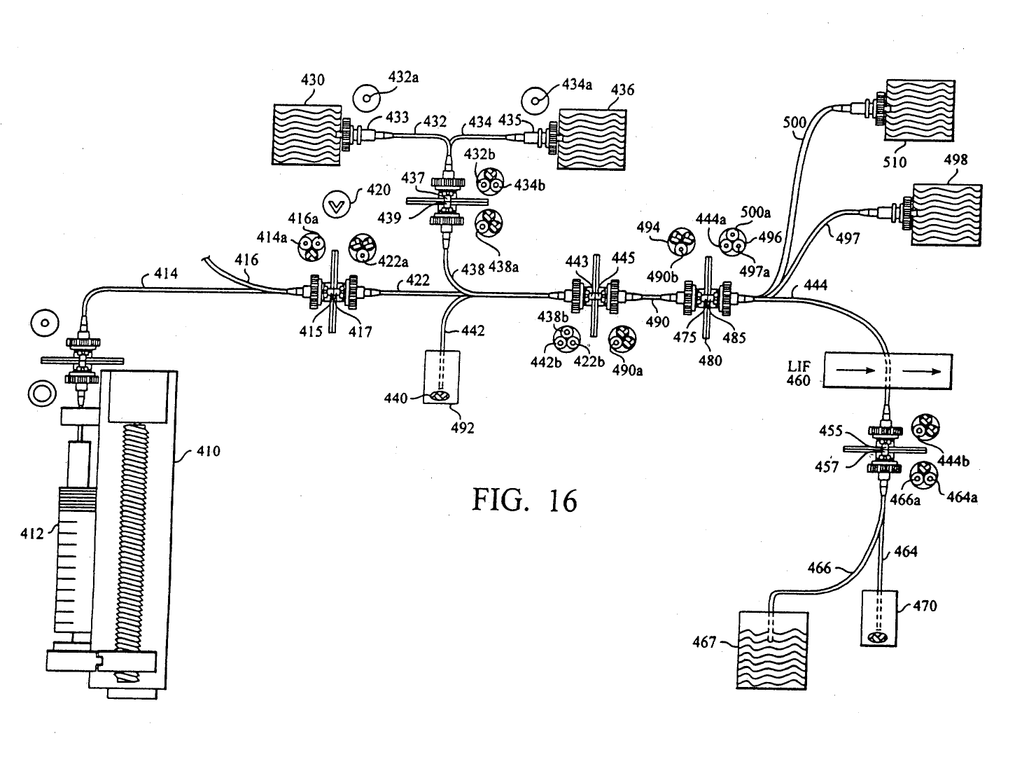

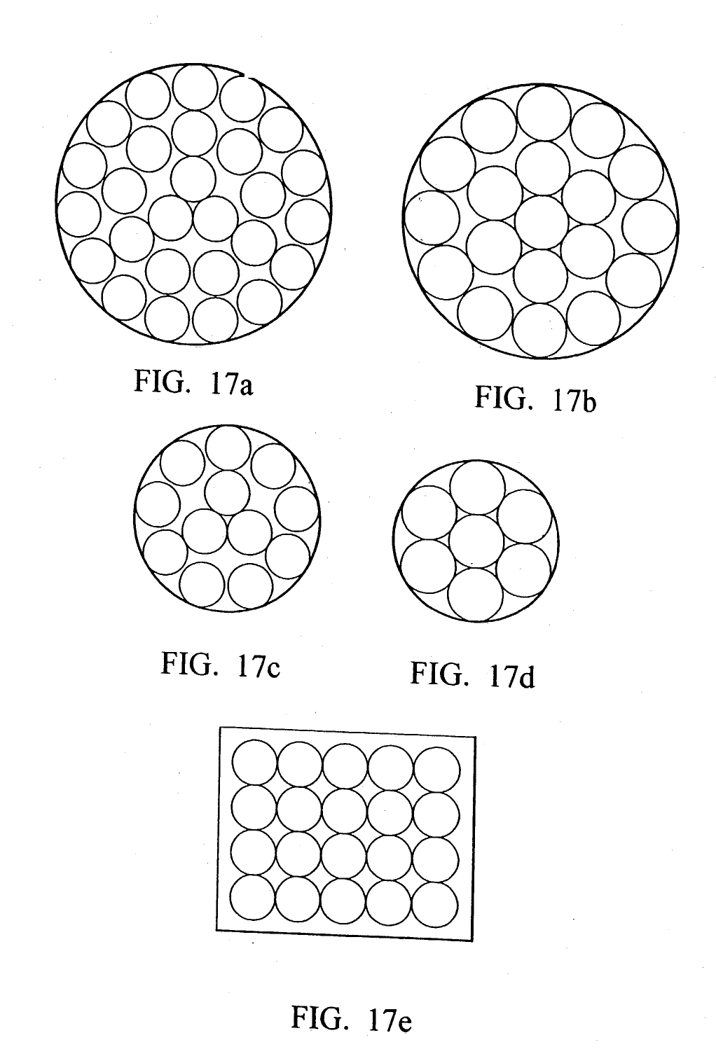

The preferred arrangement of capillary tubes within a ferrule is shown by the examples of FIGS. 17a-17e. FIG. 17a shows an outer ring of fifteen capillaries surrounding an intermediate ring of nine capillaries which, in turn, surrounds an inner ring of three capillaries. FIG. 17b shows an outer ring of twelve capillaries surrounding an intermediate ring of six capillaries which, in turn, surrounds a single capillary. FIG. 17c shows an outer ring of nine capillaries surrounding an inner ring of three capillaries. FIG. 17d shows an outer ring of six capillaries surrounding a single capillary. FIG. 17e shows a rectangular array of capillaries. In each case, capillaries are tangent to other capillaries. To achieve tangency, the capillaries are preferably the same size so that close packing can be achieved. Fibers are interchangeable with capillaries but, if difficulty is encountered in obtaining optical fibers, which are the same size as capillaries, plugged capillaries are used. The geometries illustrated in FIGS. 17a-17e are illustrative examples of close packing. Other geometries exist.

With specific reference to FIG. 17e, a rectangular array of capillary tubes may be adapted in the present connector. The basic elements of the connectors, two sections holding multiple capillaries and a fastener that holds the sections together in a face-to-face biased alignment is retained. This configuration allows the capillary connector to connect multiple capillary tubes. As with the other embodiments, the resulting connectors will be simple to use, inexpensive to manufacture and allow the rapid coupling and uncoupling of capillary tubes to either other capillary tubes or to other apparatus.

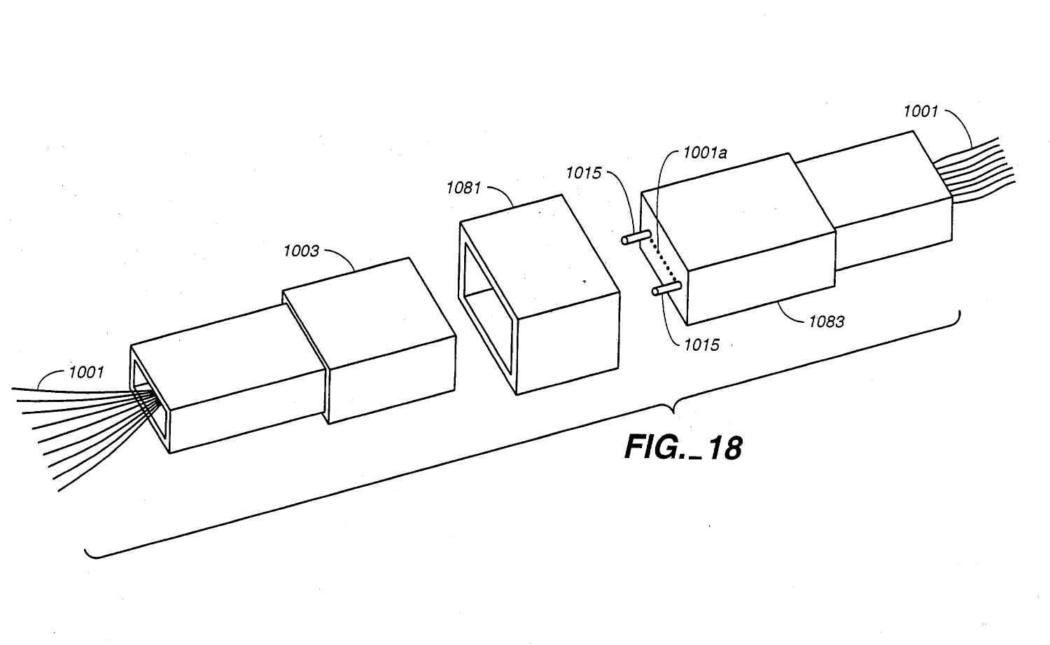

FIG. 18 illustrates the alternative connector type. As was seen in previous connector embodiments, a central coupler 1081 holds two connector halves 1003, 1083, together. Coupler 1081 holds the two connector halves with the ends of each half aligning and the adjoining faces biased against one another. As was seen in the connector described in connection with FIGS. 1-8, connector halves 1003, 1083 each are secured by central coupler 1081 and held within coupler 1081 such that a spring exerts pressure onto the appressed faces of the connector halves. The capillary tube sections 1001 terminate with open ends 1001a at end face of each connector half. Pins 1015 on connector half 1083 fit into holes on connector half 1003 to precisely position the connector halves to ensure the capillary ends align. As was seen in the previous connector, this connector may be manufactured from fiber optic connectors or may be manufactured specifically for this application. The optical fiber is removed and replaced with a capillary tube. The ends of the capillary tubes may be a single row, as shown in FIG. 18, or may be an array of capillary tubes, as shown in FIG. 17e. For example, connectors may be modified to remove optical fibers and replace them with capillary tube sections and concentrating contact force at the location of the capillary ends.

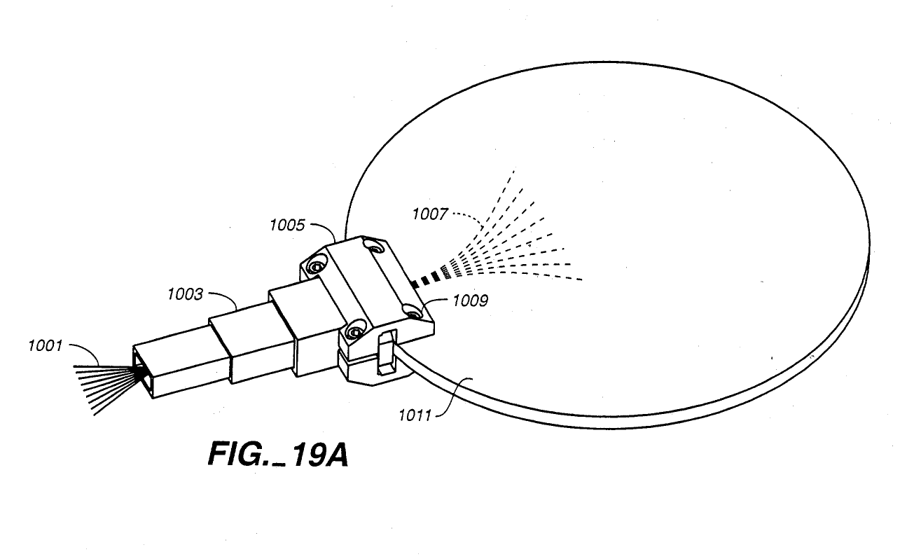

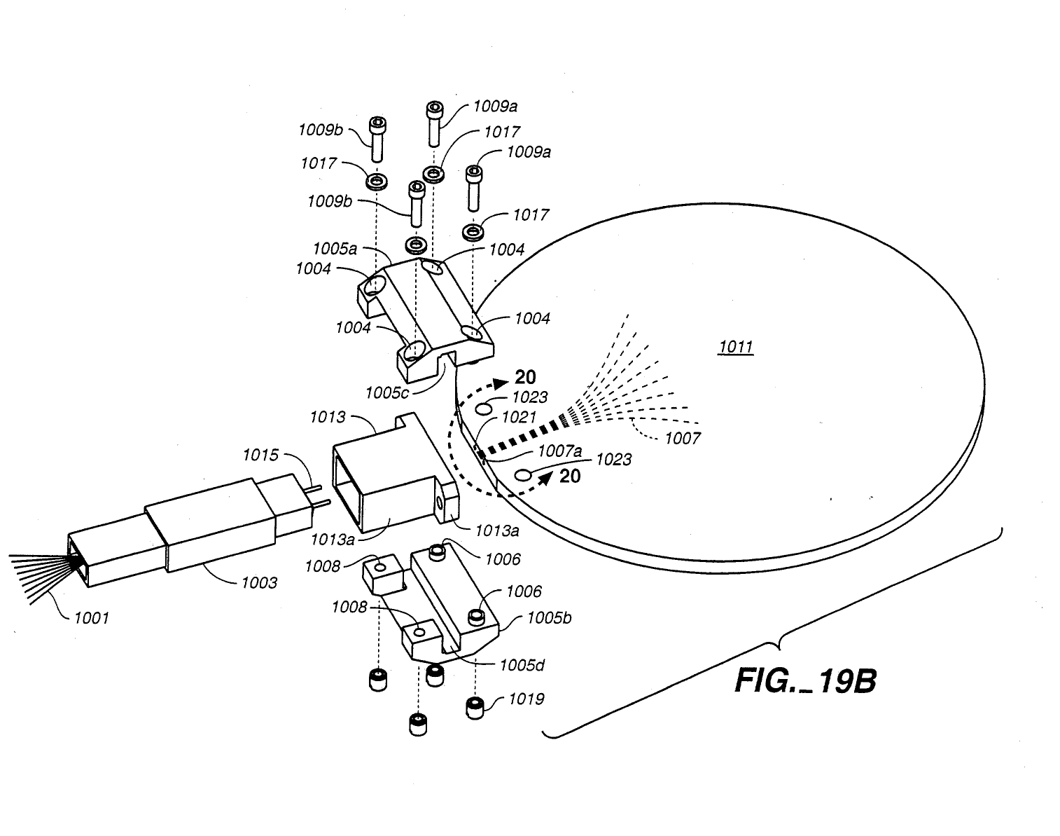

As noted, the present coupler allows coupling of microfluidic devices in a simple and straightforward manner. Examples 1-5 illustrate how the connector may be coupled to various devices to effect various tasks. Another use of the connector of the present invention coupled to a device is shown in FIG. 19a. A number of capillary tubes 1001 secured within connector 1003 terminate at the face of this connector. Connector 1003 is attached by bracket 1005 to analytical substrate 1011. Bracket 1005 is attached to substrate 1011 by bolt 1009. The connector allows the open ends of capillary tubes 1001 to pass fluid into microchannels 1007 on substrate 1011.

In FIG. 19b, the separate components of this connector are shown. Capillary tubes 1001 terminate at the face of the connector. Pins 1015 extend from the face of the connector. These pins mate with holes 1021 in substrate 1011 and provide a means for precise alignment of the connector and the substrate. In an alternate embodiment, surface features on the face of the connector 1003 would align with surface features on the substrate 1011. Returning to he present embodiment in FIG. 19b, connector 1003 is held within coupler 1013. Bracket half 1005a fits over the top of coupler 1013 and bracket 1005b fits over the bottom of coupler 1013. Grooves 1005c, 1005d fit against flange 1013a to securely hold the coupler to the bracket. The front portions of brackets 1005a, 1005b are secured through substrate 1011. Rings 1006 extend through holes 1023 on substrate 1011. Bolts 1009a extend through washers 1017 and holes 1004 on bracket 1005a, through holes 1023 on substrate 1011 and through rings 1006 on bracket 1005b. Nuts 1019 secure the bolts. The back of the brackets 1005a, 1005b are secured by bolts 1009b that extend through washers 1017, holes 1004, 1008 and are secured by nuts 1019. In this manner, brackets 1005a, 1005b securely hold coupler 1013 to substrate 1011.

When the pieces are fit together, as shown in FIG. 19a, pins 1015 fit into holes 1021, positioning the connector. Connector 1003 latches into coupler 1013. Coupler 1013 is attached to the substrate 1101 by brackets 1005a, 1005b. The ends of capillary tubes 1001 terminate at the face of connector 1003. These ends align with the open ends 1007a of microchannels 1007. These channels are etched, diced, cast or otherwise manufactured into the substrate 1011. The capillary tubes 1001 are positioned such that fluid may flow from capillary tubes 1001 into microchannels 1007. Connector 1003 is inserted into coupler 1013 and held by a latch within the connector. A spring presses the end of connector 1003 against the adjoining face of substrate 1011.

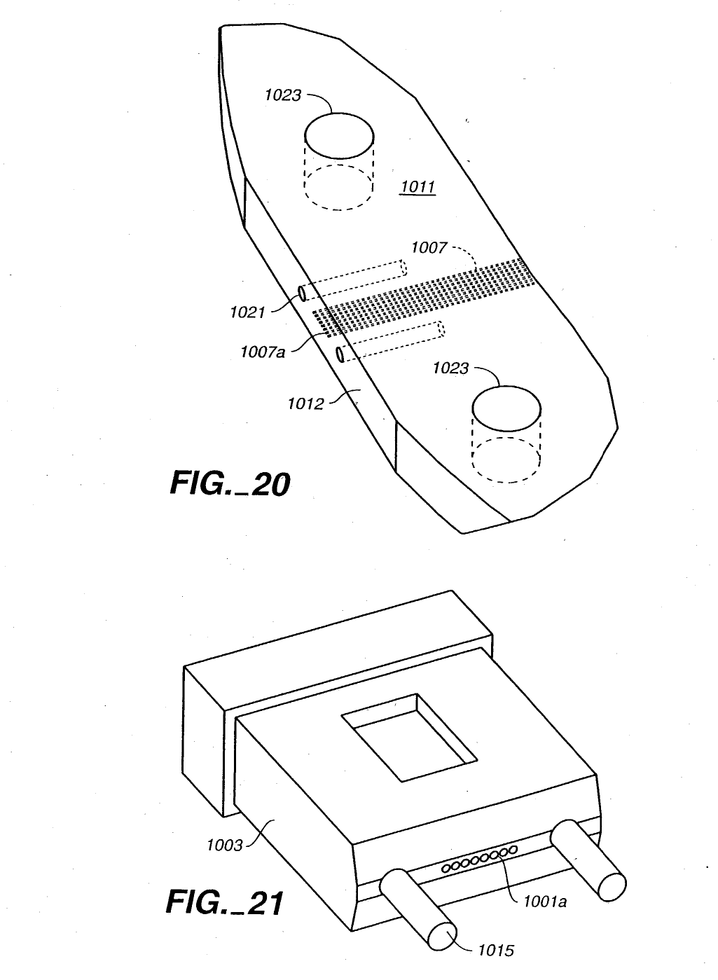

The end face of the substrate is shown in FIG. 20. The microchannels 1007 terminate on flat face 1012 on substrate 1011. Holes 1023 extend through the thickness of substrate 1011. The bolts pass through this hole, securing the bracket onto the substrate, as described in conjunction with FIG. 19b. Holes 1021 mate with the pins on a connector, to properly align the connector on face 1012. The mating connector 1003 is shown in FIG. 21. The capillary tubes terminate at capillary tube ends 1001a at the face on the connector. Pins 1015 fit into the connector to allow the connector to be aligned with substrate such that capillary tube ends 1001a align with microchannels ends 1007a.

An alternative embodiment would obviate the need for holes 1023, bolts 1009, rings 1017 and nuts 1019 by using a quick release type device that clips onto features in the substrate 1011.

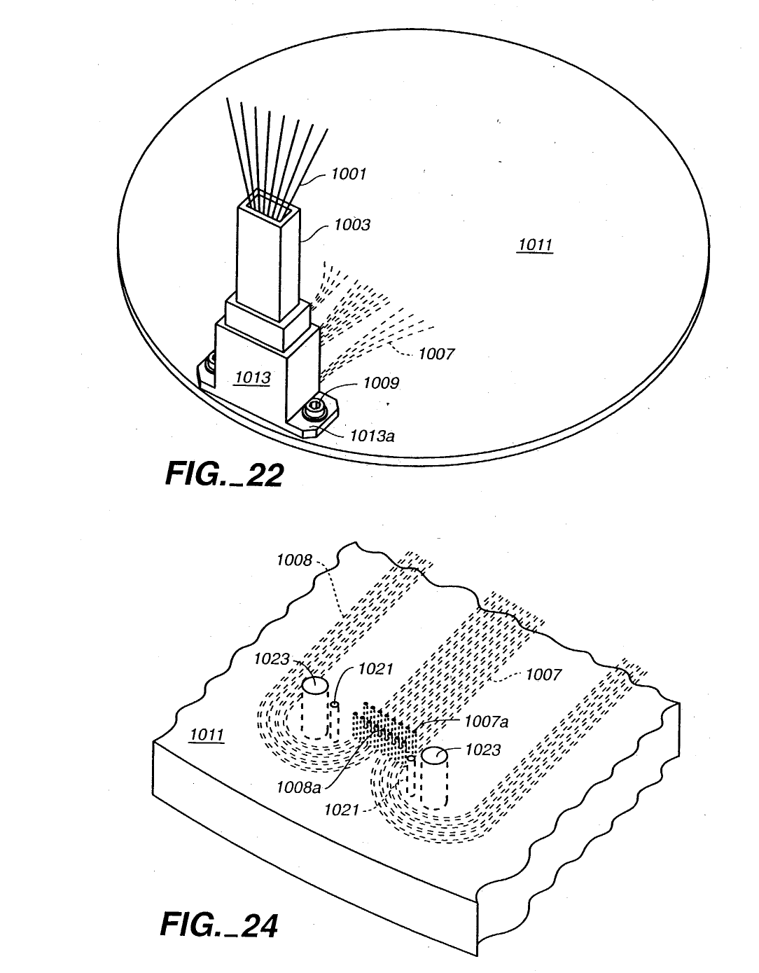

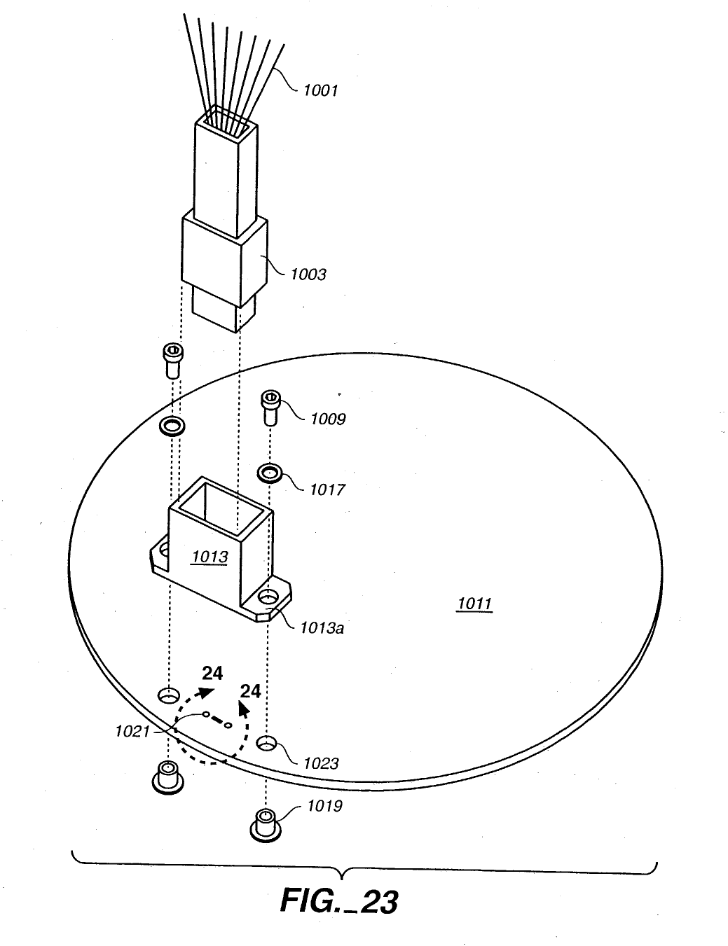

An alternative embodiment of the connector secured to a chip is illustrated in FIG. 22. Here, instead of the connector being secured to the side of the substrate by brackets, as shown in FIGS. 19a, 19b, the connector is attached to the top of substrate 1011. The flanges 1013a of coupler 1013 are secured to substrate 1011 by bolts 1009. Capillary tubes 1001 terminate at the face of the connector 1003. As seen in FIGS. 19a, 19b, connector 1003 is latched into coupler 1013 and held with a spring bias against substrate 1011. The open ends of the capillary are positioned to align with the open ends of microchannels 1007. In this example the microchannels have an open end at the top of the substrate. The attachment of the connector to the substrate is illustrated in FIG. 23. Coupler 1013 is attached to substrate 1011 by bolts 1009. Bolts 1009 pass through washer 1017, through a hole on flange 1013a on coupler 1013 and through holes 1023 on substrate 1011. On the opposite side of the substrate, nuts 1019 secure the bolts. Pins (not shown) fit into holes 1021 in substrate 1011 to allow precise positioning of the connector. Connector 1003 is latched into coupler 1013 to bring the ends of capillary tubes 1001 into fluid communication with the ends of the microchannels on substrate 1011.

FIG. 24 illustrates an area of the substrate where the connector is placed. Holes 1023 accommodate bolts that pass through substrate 1011 to secure the coupler to the substrate. Holes 1021 mate with pins on the face of the connector, allowing precise positioning of the connector. Microchannels 1007, 1008 pass through substrate 1011. These microchannels have openings 1007a, 1008a on the top of the substrate. The connector brings the end of the capillary tubes into fluid communication with the microchannels. In this embodiment, the connector has two rows of capillary tube ends on the face of the connector, to match with the two rows of microchannel openings on the substrate. In an alternative embodiment, the capillary tubes are replaced by a microdevice with microchannels.

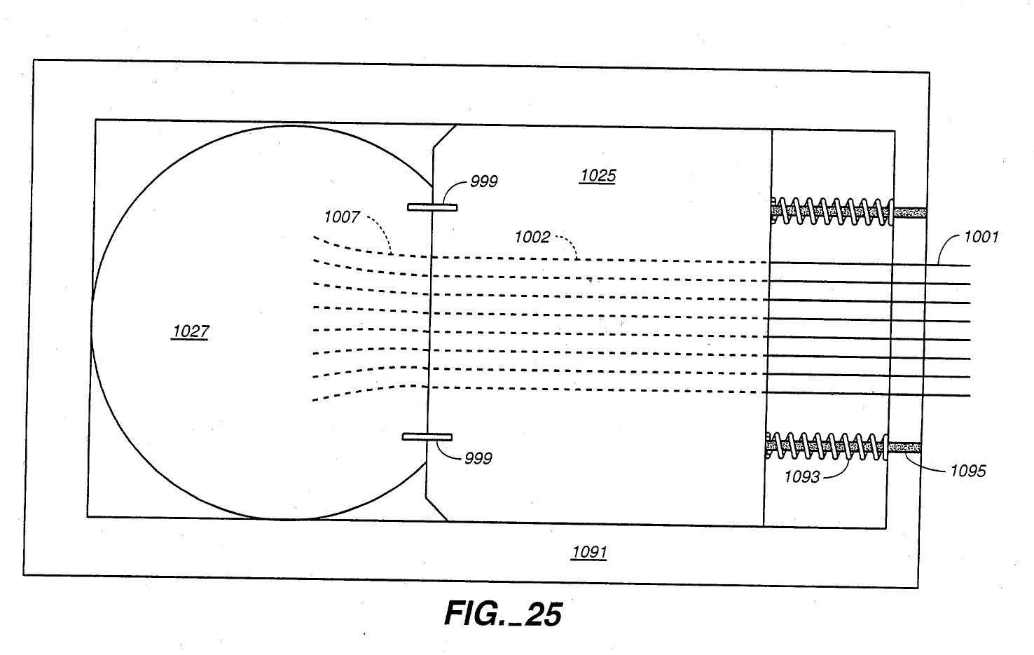

FIG. 25 shows another connector bringing the capillary tube ends into communication with microchannels on a substrate. Tray 1091 holds a microfluidic device 1027 and a microchannel connector 1025. The microfluidic device could contain single functionalities such as sample preparation or analysis or contain integration of multiple steps on each microfluidic device. For example, one microfluidic device could contain functionality for PCR and cycle sequencing and another microfluidic device could contain sample cleanup and analysis functionality. The microchannel connector 1025 has a number of capillary dimension channels 1002. At one end of the connector substrate channels are joined to capillary tube sections 1001. At an opposite end, the ends of channels 1002 are in contact with the ends of microchannels 1007 on microfluidic device 1027. Pins 999 align the connector 1025 with the microfluidic device 1027. The channels 1002 may be produced in a number of ways, including dicing a first substrate to form channels and overlaying a second substrate over the first. Alternatively, capillary tubes could be fit through grooves running through the center of the connector substrates. Springs 1093 mounted on post 1095 bias the end of the connector substrate against the side of the microfluidic device 1027.

This tray-type connector may also be used for joining two substrate connectors. In FIG. 28, microchannel connector halves 1025 and 1028 are held together in tray 1091. Springs 1031 are mounted to apply force on either end of the combining substrate. Bars 1033 on one side of the tray and springs 1029 on the opposite side of the tray fit against the sides of the microchannel connector 1025, 1028, holding the substrates in place. Pins 999 align the connector halves. Capillary tube sections extend from either side of the connector substrates 1001. The bars 1033 could also be movable, for example by a stage, to move the alignment of microchannel connector halves 1025 and 1028. The tray 1091 can also be adapted to interface the microfluidic device 1027 shown in FIG. 25 with a microchannel connector half 1025 shown in FIG. 28 or two microfluidic devices.

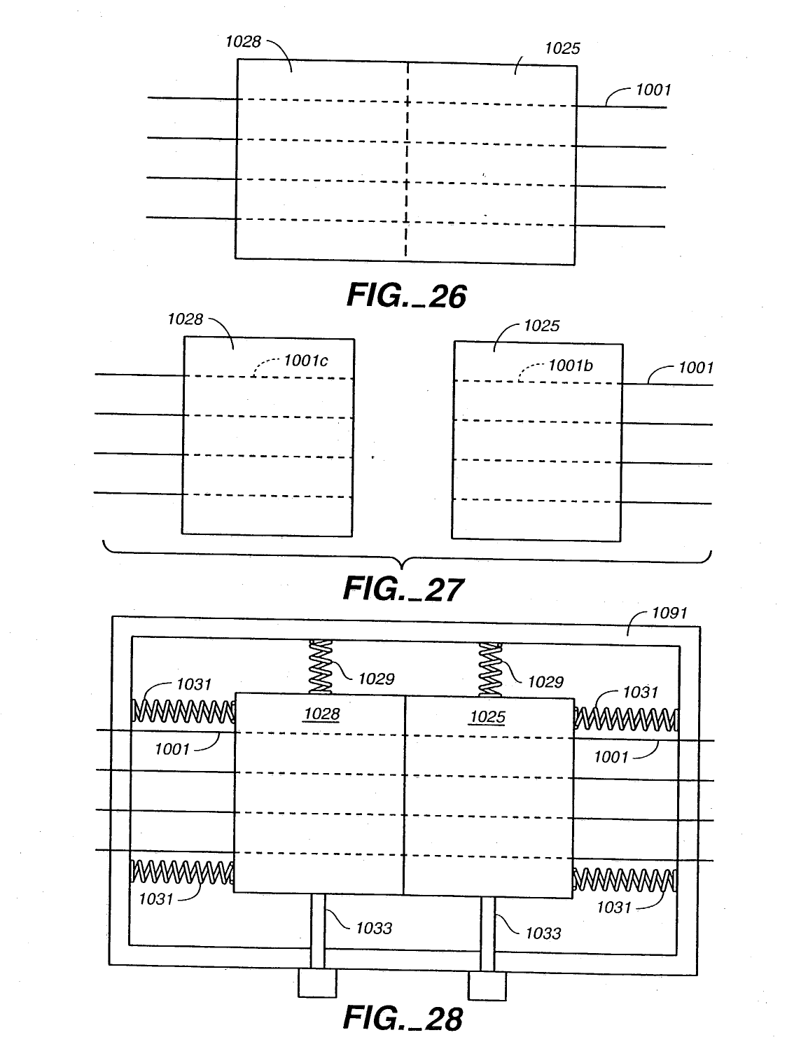

The connector substrates are shown in FIGS. 26 and 27. Microchannel connectors 1028, 1025 each have capillary tube sections 1001 entering one side and terminating at a face on the connector. The internal channels 1001c, 1001b within each substrate may be formed by various means. These means include two layers of a material that are bonded together to form the substrate. One, of the layers has channels that may be diced, etched, molded, embossed or otherwise formed on one of the layers. Alternatively, a capillary tube may be bonded between two material layers to form the connector substrate. The capillary tube sections would extend from either side of this substrate. The substrate could then be cut in half across the embedded capillary tubes. This manufacturing method produces two connector halves that are assured of having proper microchannel alignment. Polishing of the ends of the connector halves can produce surfaces that provide a strong seal.

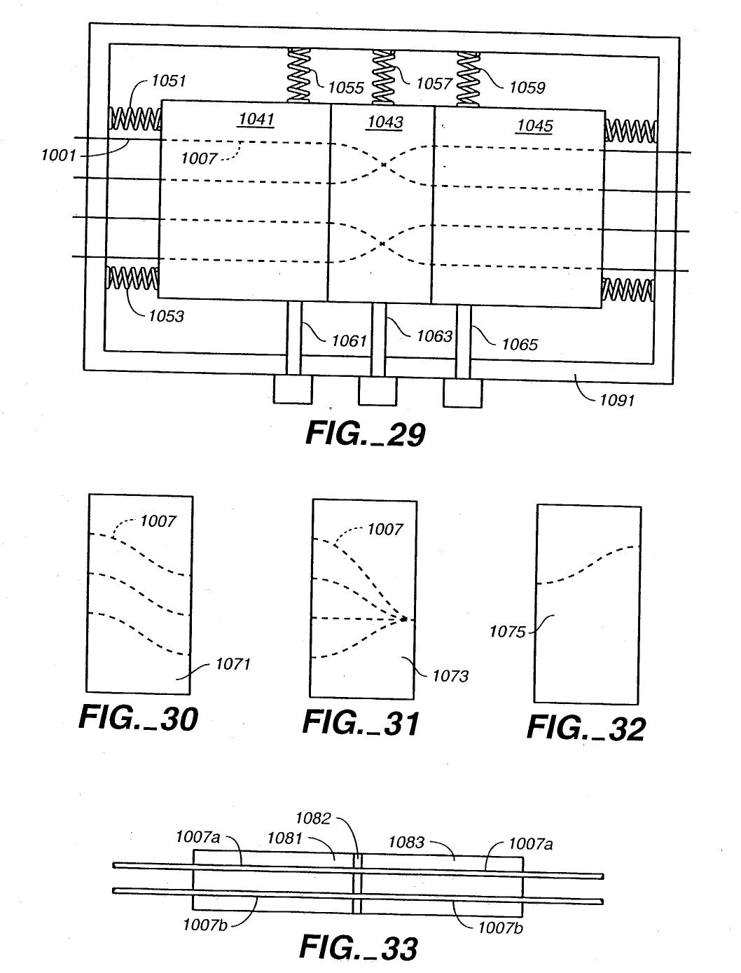

This connection of connector substrates could also be modified such that the connectors could function as a router or manifold. In FIG. 29, tray 1091 has been modified to include a central routing substrate 1043 between connector substrates 1041 and 1045. Each connector substrate 1041, 1045 has capillary tube sections 1001 entering into one side of the substrate. These sections are joined to the substrate such that they flow into internal microchannels 1007 extending through the interior of each substrate. End springs 1051 apply a biasing force against the ends of the substrates. The microchannels are thus joined with sufficient force that high-pressure fluid within the microchannels would not leak. Between substrates 1041 and substrates 1045 is router substrate 1043. The microchannels of router substrate 1043 route fluid from the microchannels of substrate 1041 to the microchannels of substrate 1045. The microchannels are manufactured such that at the locations where the microchannels cross, the microchannels are at different layers of the substrate. In this way, the contents of the microchannels do not combine while the fluid in the microchannels in substrate 1041 are routed to a selected microchannel in substrate 1045.

The sides of the connector substrates 1041, 1045 and router substrate 1043 are positioned by springs 1055, 1057, and 1059 and positioning bolts 1061, 1063 and 1065. Each substrate is positioned by at least one bolt and one spring. The springs are opposite the bolts and provide a biasing force, holding the substrates laterally in place.

Other positioning embodiments are possible to one skilled in the art. Precision alignment by a tray that could eliminate springs 1055, 1057 and 1059 as well as positioning bolts 1061, 1063, and 1065 are envisioned.

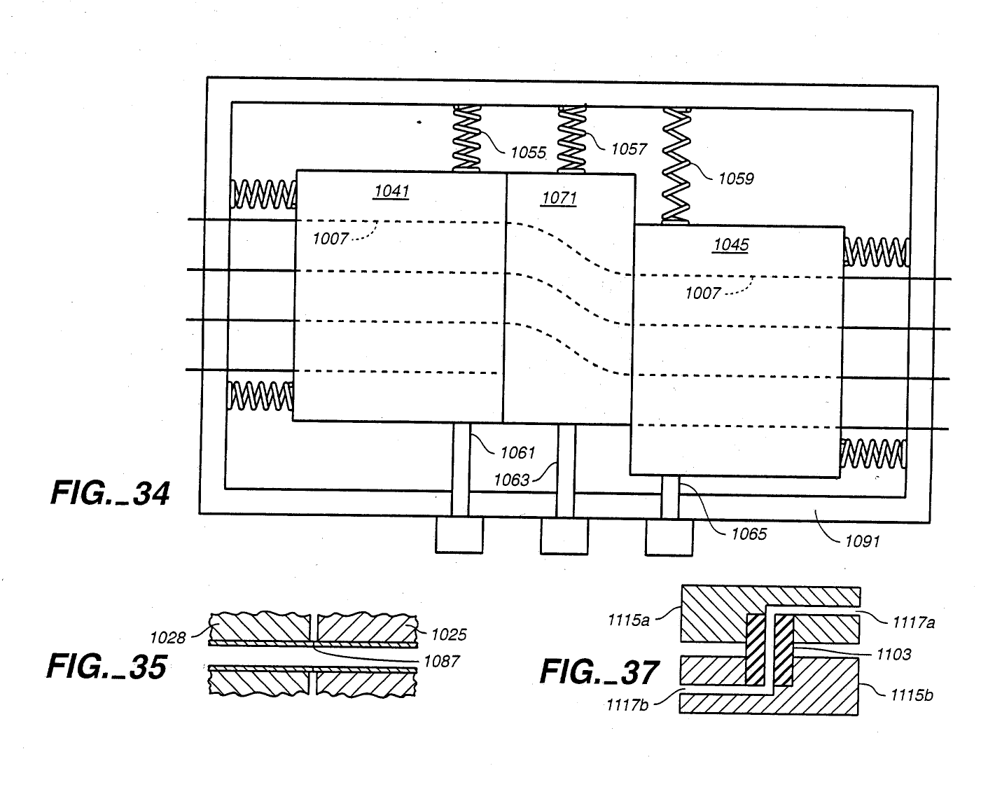

FIG. 34 illustrates this type of connector as used to direct the flow of fluid. The tray 1091 again holds connector substrates 1041 and 1045 separated by a routing substrate 1071. Again, springs 1055, 1057 and 1059 bias the sides of the substrates against bolts 1061, 1063, 1065. Bolt 1065 has been repositioned such that connector substrate 1045 is laterally repositioned. This results in the microchannels 1007 aligning such that the first three microchannels on each connector substrate are brought into fluid communication. If bolt 1065 is repositioned into the orientation shown in FIG. 29, the first three microchannels on connector substrate 1041 are brought into fluid communication with the second through fourth microchannels on connector substrate 1045. Alternatively, if bolt 1065 is repositioned into an orientation where the first three microchannels on connector substrate 1041 are not brought into fluid communication with the second through fourth microchannels on connector substrate 1045, a closed valve is created.

If positioning bolts 1061, 1063 and 1065 are attached to mechanisms such as stages that allow computer controlled alteration of the stop position of the bolts, connector substrates 1041, 1045 and router substrate 1043, the relative positions of connector substrates 1041, 1045 and router substrate 1043 can be altered under computer control, leading to a programable microfluidic router and valve.

The use of the present system allows the central routing substrate to be used for various functions. For example, the routing substrates 1071, 1075 of FIGS. 30, 32 each contain microchannels 1007 that route fluid from one connecting microchannel to a second connecting microchannel. These routing substrates may also be used to meter liquid. The microchannels 1007 each have a known, defined volume. Once each micro-channel in the routing substrate is filled, a connecting microchannel may be positioned to receive the fluid in the routing substrate microchannel. In this way a defined volume of fluid may be routed into a specific microchannel pathway. The volume of the fluid can be controlled by uniform or non-uniform channel dimensions including having sample chambers to defined volumes to perform reactions or to deliver a known volume to an analytic device such as a capillary electrophoresis instrument, a microfluidic device with capillary electrophoresis functionality, or a mass spectrometer; other analysis devices are obvious to one skilled in the art. The volume can range from microliters to nanoliter and picoliters. If the analytical device is a capillary electrophoresis microchip, the delivery of the known volume can replace the function of a cross-channel injector or “twin T injector.”

Another possible use of the routing substrate is for use as a connector. In FIG. 31, routing substrate 1073 includes a number of microchannels 1007 that come together to form a single outflow channel. In this way, the contents of several capillary tube sections could be combined into a single capillary tube or microchannel or split into several streams. This would be useful in the assembly of reaction mixtures.

The microchannels and associated capillary tube sections may be used with a single layer of microchannels on each connector. Alternatively, an array of capillaries may be used with each connector. In FIG. 33, a side cutaway of substrate connectors shows connector substrates 1081 and 1083 joined. A top set of microchannels 1007a and a bottom set of microchannels 1007b are both connected by bringing the two substrates into alignment. This allows a higher density of capillary tube sections or microchannels to be connected. A gasket 1082 between substrates 1081, 1083 allows for some resiliency, providing a more even distribution of the force joining the substrates. A pair of substrates joined using such a gasket pressure tested without leaks at 800 psi with air. Such a gasket could be made of TeflonJ, TygonJ, silicone or other resilient material. To ensure alignment, holes in the gasket could match to pin locations on a substrate. When the gasket is fit over the pins, the holes in the gaskets align with the microchannel openings in the substrates. An alternative embodiment utilizes resilient materials such as plastics to form self-sealing microfluidic connectors or self-sealing microfluidic devices.

In the various embodiments of the connectors, a spring is used to bias the ends of the connector to seal capillary dimension sections into a leak-tight connection. Concentrating the sealing force at the location of the microchannel may enhance the force sealing the capillary sections. One way this is done is by having the ends of the microchannels slightly raised on the faces of the joined connector halves. For example, in the fiber optic-like connectors, the capillary tube sections may be inserted so that the sections extend slightly from the face of the connector. The capillary end may then be polished back such that the end extends slightly from the face. The result is shown in FIG. 35. Here the ends of the capillary tube sections join at their ends 1087, which extend from the face of the microchannel connectors 1028, 1025. Because the only area that is touching is the ends of the capillary tube sections, the biasing force is concentrated at these ends. This increases the sealing pressure and ensures that the capillary connectors would be leak free, even under high pressure. An alternate embodiment replaces the capillaries with microfluidic devices where the capillary tubes are replaced with microchannels. The raised section 1087 would be fabricated into the ends of the microfluidic devices.

In FIGS. 25-35, the attachment of substrates in a side-to-side orientation is illustrated. The open ends of microchannels are brought into alignment as the substrates are mutually biased against each other. This has proven to be a robust method to allow flow from one microchannel to another. These connections have been demonstrated to be leak tight, even at pressures up to 800 psi.

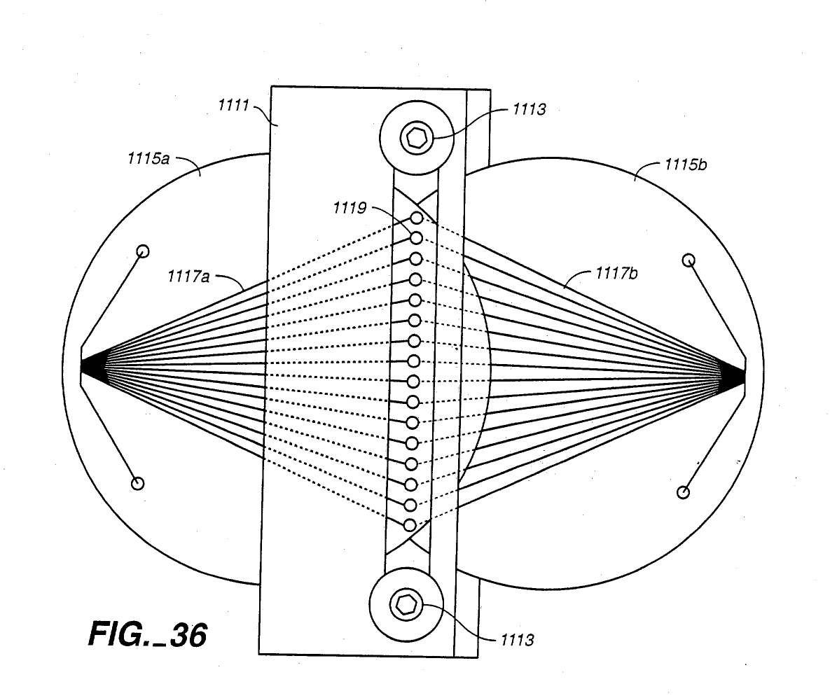

In FIGS. 36-37, an alternative embodiment is shown in which substrates are joined in a stacking orientation. As before, the openings to microchannels are brought into close proximity and held in mutually biased alignment. In this alignment, the open ends of the microchannels allow fluid communication between microchannels. As seen before, the use of a resilient material between the open ends of the microchannels allows fluid tight joining of the microchannels, even at high pressures.

With reference to FIG. 36, capillary chips 1115a and 1115b are joined by clamp 1111 secured by bolts 1113. In addition to bolts, a pinch clamp or spring loaded bolt could secure the clamp and provide a variable clamping pressure. Clamp 1111 is positioned above and below the joining sections of chips 1115a, 1115b. Microchannels 1117a and 1117b meet at opening 1119. Each microchannel has an opening on the face of the associated chips. The openings for the microchannels on each chip have equal spacing, allowing alignment when the chips are positioned face to face. Clamp 1111 distributes an even clamping force across the width of each chip. In this manner liquid from one microchannel on one chip may flow into a micro-channel on a corresponding chip.

The stacked chips offer a very stable means of allowing fluid flow from one chip to another. However, one problem is producing reliable fluid flow. This is best ensured if the diameter of the microchannels is the same. However, in connecting capillary chips, the diameter of the microchannel can be much smaller than the diameter of the opening. In the glass commonly used to manufacture microfluidic chips, the opening to the microchannel is bored into the chip. The smallest holes that can be easily manufactured are about 1-2 mm diameter. This is an order of magnitude larger than the microchannel diameter of about 100 um. This problem is solved by using a section of resilient tubing which is fit into the opening holes. The interior bore of this tubing is matched to the microchannel width. The resilient tubing also acts to align the chip openings.

In FIG. 37 top chip 1115a is joined to bottom chip 1115b by a section of TygonJ tubing 1103 or other resilient material inserted into an opening drilled into each chip. The holes in the chips are matched to the size of the connector so that a tight fit is produced. The interior diameter of the tubing is matched to the diameter of the microchannels. This is preferred to ensure a more even flow of fluid from one microchannel to another and prevent a sudden change in velocity produced by a large change in diameter. In one embodiment, a section of silica capillary tube is inserted into section of resilient tubing. This gives this tubing added stiffness and ensures a more uniform interior bore that will not deform with added pressure. Microchannels 1117a, 1117b are joined with this fitting, allowing fluid to flow from one capillary to the other. This type of system has been pressured tested as leak free up to 800 psi.

Alternative embodiments use the resilient piece 1103 to add features such as volumetric control to process the sample. Arrangements with arrays of resilient piece 1103 manufactured in a substrate are within the scope of the instant invention. Processing is comprised of bead based separation including reactions with components affixed or added to the surface of other resilient member or other features. The resilient matter could also be a reaction chamber or an array of reaction chambers and could be disposable. One application would be as a diagnostic device. Different chemistries could be affixed to the surface and fluidics delivered through a system of routers, mixers and other components described above.

The disposable resilient matter could act as a disposable component, the advantages to clinical and other applications obvious to one skilled in the art. As described earlier, the devices may be included in automated systems that process microfluidic devices.

In one manufactured example, 3 mm sections of TygonJ tubing (2 mm outer diameter, 0.25 mm inner diameter) were cut and secured into all microchannel openings on a capillary chip. The openings are 1 mm deep, allowing the 3 mm long resilient tubing section to extend into both holes. When pressure is evenly applied across the area to be joined the resilient tubing expands into the openings, producing a pressure tight seal. Proper chip opening alignment is needed for the connection of the two chips.

The present sections of resilient tubing may be manufactured as a single unitary gasket with a number of tubing protrusions. This gasket would allow fluidic connection of a plurality of microchannels. In addition, the chips could be designed with features, such as positioning pins, to allow for simplified alignment of the chips. The positioning pins could also alter the relative position of the chips to allow routing of liquids or gases between chips. The chips can also connect to capillary tubes as illustrated in FIGS. 18, 19, 22, and 25.

It is apparent that many modifications and variations of the invention as hereinabove set forth may be made without departing from the spirit and scope thereof. The specific embodiments described are given by way of example only, and the invention is limited only by the terms of the appended claims.

What is claimed is:

1. A capillary connector comprising:
a first and a second member having capillary tubes enter a first end of said members and having open ends at a level face on a second, opposite end of said members;
a coupler, said coupler receiving said first and second member and securing said first and second member in a mutually biased alignment, such that the open ends of the capillary tubes are brought into alignment.

2. The capillary connector of claim 1, wherein said connector is a fiber optic connector, having a first and second connector half and a coupler that may join together said first and second connector halves, said halves having optical fibers removed and replaced with capillary tubes.

3. The capillary connector of claim 1, further comprising positioning pins located on said first capillary holder and fitting into receiving holes on said second holder, said pins positioning the holder faces such that the capillary ends align.

4. The capillary connector of claim 1, wherein the mutually biased alignment of the connector faces is effected by a spring.

5. The capillary connector of claim 1, wherein said open ends extend from said level face on each member to a sufficient extent that biasing force is concentrated at said end upon alignment.

6. The connector of claim 1, wherein said first and second members are substrates and said capillary tubes extend into microchannels in said substrates, wherein said coupler is a tray holding said substrates such that the level face of each substrate is held in biased alignment.

7. The connector of claim 6, wherein the substrates are comprised of two joined layers, wherein capillary tubes extend between said layers.

8. The connector of claim 6, wherein the tray further includes a set offsprings to provide a biasing force to all sides of the substrates.

9. The connector of claim 8, wherein the tray includes a set of bolts or fasteners on one side of the substrates opposite a set of springs on an opposite side of the substrates, whereby moving said bolt allows sideways positioning of the substrates.

10. The connector of claim 9, further comprising a routing substrate, said routing substrate having microchannels extending across said routing substrate, said substrate positioned between the level faces of the members such that capillary tubes on the first and second member are brought into fluid communication.

11. The connector of claim 10 wherein said routing substrate acts as a manifold such that a plurality of capillary tubes associated with the first member are in fluid communication with a single capillary tube on the second member.

12. A device for bringing the ends of capillary tubes into fluid communication with a receiving passageway, the device comprising:
a capillary holder, said holder having a plurality of capillary tubes entering a first end of said holder and terminating at a level face on a second end of said holder; and
a mount, said mount holding said capillary holder in a fixed position in relation to openings of said receiving passageways such that the ends of said passageway align with the ends of the capillary tubes, and said mount exerting a biasing force on said holder towards the receiving passageways.

13. The device of claim 12, further comprising at least one positioning pin on said level face, said pin mating with a hole located in relation to said receiving passageways, such that when said pin is inserted in said hole the capillary tube ends align with the receiving passageway.

14. The device of claim 12, wherein said receiving passageways are opening of capillary dimension channels on a substrate.

15. The device of claim 14, wherein said mount is comprised of a coupler that holds said capillary holder in a fixed position and biases the level face of said holder against the opening of the receiving passageways, and a bracket that hold the coupler in a fixed position on said substrate.

16. The device of claim 14, wherein said mount includes a fastener that extends through said substrate, securing the coupler to the substrate.

17. The device of claim 14, wherein the receiving passageways are capillary electrophoresis channels.

18. The device of claim 12, wherein said capillary holder is a substrate comprised of two joined layers wherein the capillary tubes enter into one side of the substrate and have open ends at a second end of said substrate, and wherein said mount includes a tray into which the capillary holder and a receiving substrate are positioned, said tray positioning said capillary holder and said receiving substrate such that open capillary ends on the holder are in biased alignment with microchannels on the receiving substrate.

19. A device for connecting capillary tubes adapted from an optical fiber connector comprised of a first and a second connector half, each half designed to have at least one optical fiber entering one end of each half and terminating at a level face on a second end of said half, and a coupler, said coupler securely holding each connector half and holding the face of each coupler in mutually biased alignment such that the ends of said fibers in each half that terminate at each face may be bought into end to end alignment, the device comprising:
locating in each connector half in the place of at least one optical fiber at least one capillary tube, such that when each connector half is joined by the coupler, ends of the capillary tubes are brought into mutually biased fluid communication.

20. The device of claim 19, wherein each connector half includes a rotatable ferrule and the capillary tube is secured within said ferrule and terminates at the face of the ferrule.

21. The device of claim 20, further comprising a positioning key, wherein said key secures each ferrule in a secured rotational position.

22. The device of claim 20, wherein each connector half further includes a nut, annularly secured to said ferrule and said coupler includes two threaded ends, whereby when said nuts are secured onto said coupler ends, the faces of the ferrules are brought into mutually biased alignment.

23. The device of claim 20, further including a strain relief boot attached to each connector half an end of each connector where said fibers enter said connector half.

24. The device of claim 19, wherein each capillary tube end is raised from the surface of the level face, such that biasing pressure is concentrated at the capillary tube ends when capillary tubes align.

25. The device of claim 24, wherein each level face is rectangular.

26. The device of claim 25, further comprising positioning pins extending from the level face of a first connector half, said pins fitting into positioning holes on the face of the second connector half.

27. The device of claim 26, further including a latch securing each connector half to the coupler.

28. A device for allowing leak free joining of microchannels on two devices, the device comprising:
a first and a second microfluidic device, each microfluidic device having a plurality of microchannels extending a length of said device, said microchannels terminating at openings on a surface of each of said microfluidic devices, wherein openings on the first microfluidic device are symmetrically positioned in relation to openings on said second microfluidic device such that said surface of the first microfluidic device may be orientated in relation to said surface of said second microfluidic device such that said openings on said first microfluidic device align with openings on said second microfluidic device, and
a clamp joining said first and second microfluidic devices, such that said first and second microfluidic devices are secured in a mutually biased alignment distributed across an area of said microfluidic devices, said area including said openings on the first and second microfluidic devices.

29. The device of claim 28, wherein said openings on said first microfluidic device are on an edge of said first microfluidic device and said openings on said second microfluidic device are on a face of said second microfluidic device.

30. The device of claim 28, wherein said openings on said first microfluidic device are on an edge of said first microfluidic device and said openings on said second microfluidic device are on an edge of said second microfluidic device.

31. The device of claim 28, wherein said openings on said first microfluidic device are on a face of said first microfluidic device and said openings on said second microfluidic device are on a face of said second microfluidic device.

32. The device of claim 28, further comprising a resilient gasket interposed between said first and second microfluidic devices, said gasket disposed at a location of aligned microchannel openings, said gasket having holes positioned at each pair of openings.

33. The device of claim 32, wherein said gasket is a self-sealing plastic.

34. The device of claim 32, wherein said gasket includes a resilient tubing extending into holes on at least one of said first and second microfluidic devices.

35. The device of claim 28, further including a pair of alignment pins on said first microfluidic device and a pair of alignment pin receiving holes in said second microfluidic device, wherein when said pins are inserted in said receiving holes openings on said first microfluidic device align with openings on said second receiving device.

36. The device of claim 28, wherein said clamp has a resilient biasing element to provide a variable compression pressure.

37. The device of claim 35, wherein said resilient element has an interior surface coated with a compound, said compound transferable to liquid passing through said resilient element.

38. The device of claim 28, wherein said microchannels are of non-uniform dimensions.

39. The connector of claim 10 wherein said routing substrate acts as a valve such that a plurality of capillary tubes associated with the first member can be positioned either in fluid communication with the second member to open the valve or positioned opposed to a solid surface on the second member to close the valve.
